(19) United States
(12) Patent Application Publication
(10) Pub. No.: US 2021/0184977 A1
(43) Pub. Date: Jun. 17, 2021

(54) CPU AND PRIORITY BASED EARLY DROP PACKET PROCESSING SYSTEMS AND METHODS

(71) Applicant: Citrix Systems, Inc., Fort Lauderdale, FL (US)

(72) Inventors: Mustafa Kutluk Testicioglu, Campbell, CA (US); Anil Shetty, Fremont, CA (US)

(21) Appl. No.: 16/716,040

(22) Filed: Dec. 16, 2019

(51) Int. Cl. H04L 12/851; H04L 12/823; H04L 12/879; H04L 29/06

(52) U.S. Cl. CPC H04L 47/2433; H04L 47/2441; H04L 63/1433; H04L 49/9026; H04L 63/1425; H04L 47/32

(57) ABSTRACT

Described embodiments provide systems and methods for CPU load and priority based early drop packet processing. A device can establish a priority level for each traffic class of a plurality of traffic classes. The device can receive a plurality of packets. The device can determine a processing level of one or more processors of the device prior to processing the plurality of packets. The device can select one or more packets of the plurality of packets to drop responsive to the priority level of one or more traffic classes associated with the one or more packets and the processing level of the one or more processors.

### BACKGROUND

Devices can include or use a plurality of software applications to perform a variety of different functions. In a network environment, a host's central processing unit serving multiple applications can be overloaded with a large number of data packets, which can result in service disruptions and failures. The overload condition can result in data packet loss.

### SUMMARY

The present disclosure is directed towards determining to drop or process packets based in part on a central processing unit (CPU) load and a priority corresponding to the respective packet. A device intermediary to a plurality of clients and one or more containerized applications can receive and process a plurality of packets corresponding to the applications. The device can make the determination to process or drop a packet based in part on a processing level of one or more processors of the device being at, near or over a processing threshold of the device. For example, the device can select one or more packets to be dropped when the processing level is at or within a defined range of the processing threshold of the device to maintain the processing level such that the processing level is less than the processing threshold or reduce the processing level such that the processing level is less than the processing threshold. The device can determine to process or drop a packet based in part on a priority level of a traffic class corresponding to the respective packet. For example, the device can select one or more packets having a low priority level to drop when the processing level is at or within a defined range of the processing threshold.

In at least one aspect, a method is provided. The method can include establishing, by a device, a priority level for each traffic class of a plurality of traffic classes. The method can include receiving, by the device, a plurality of packets. The method can include determining, by the device, a processing level of one or more processors of the device prior to processing the plurality of packets. The method can include selecting, by the device, one or more packets of the plurality of packets to drop responsive to the priority level of one or more traffic classes associated with the one or more packets and the processing level of the one or more processors.

In embodiments, the method can include assigning, by the device, a first priority level to a first traffic class corresponding to a group of applications packaged in a container and assigning, by the device, a second priority level to a second traffic class. The second traffic class can be different from the first traffic class. The method can include determining, by the device, to process a first packet associated with the first traffic based on the first priority level of the first traffic class. The method can include determining, by the device, to drop a second packet associated with the second traffic class prior to processing the second packet based on the second priority level of the second traffic class. The method can include selecting, by the device, the one or more packets to be dropped prior to processing at the device responsive to the processing level of the one or more processors being greater than a processing threshold of the device.

The method can include determining, by the device, that the processing level of the one or more processors is greater than a processing threshold of the device and selecting, by the device, the one or more packets to be dropped based on the priority level of the one or more traffic classes associated with the one or more packets. The method can include determining, by the device, the one or more traffic classes of the plurality of packets. The method can include determining, by the device, that the processing level of the one or more processors is less than a processing threshold of the device and processing, by the device, the one or more packets at the device. The method can include determining, by the device, a first traffic class corresponds to malicious traffic. The method can include dynamically modifying, by the device, the priority level of the first traffic class. The method can include dropping, by the device prior to processing, at least one packet of the plurality of packets associated with the first traffic class.

The method can include determining, by the device, the processing level of the one or more processors is equal to or greater than a processing threshold of the device and selecting, by the device using a prioritization algorithm, one or more packets of the plurality of packets to drop. The method can include determining, by the device, the processing level of the one or more processors is less than a processing threshold of the device. The method can include stopping, by the device, dropping of one or more packets of the plurality of packets. The method can include processing, by the device, the one or more packets at the device.

In at least one aspect, a system is provided. The system can include a device comprising one or more processors, coupled to memory. The device can be configured to establish a priority level for each traffic class of a plurality of traffic classes. The device can be configured to receive a plurality of packets. The device can be configured to determine a processing level of the one or more processors of the device prior to processing the plurality of packets. The device can be configured to select one or more packets of the plurality of packets to drop responsive to the priority level of one or more traffic classes associated with the one or more packets and the processing level of the one or more processors.

In embodiments, the device can be configured to assign a first priority level to a first traffic class corresponding to a group of applications packaged in a container and assign a second priority level to a second traffic class, the second traffic class different from the first traffic class. The device can be configured to determine to process a first packet associated with the first traffic based on the first priority level of the first traffic class. The device can be configured to determine to drop a second packet associated with the second traffic class prior to processing the second packet based on the second priority level of the second traffic class.

The device can be configured to select the one or more packets to be dropped prior to processing at the device responsive to the processing level of the one or more processors being greater than a processing threshold of the device. The device can be configured to determine that the processing level of the one or more processors is greater than a processing threshold of the device and select the one or more packets to be dropped based on the priority level of the one or more traffic classes associated with the one or more packets. The device can be configured to determine the one or more traffic classes of the plurality of packets. The device can be configured to determine that the processing level of the one or more processors is less than a processing threshold of the device and process the one or more packets at the device. The device can be configured to determine a first traffic class corresponds to malicious traffic and dynamically modify the priority level of the first traffic class. The device can be configured to drop, prior to processing, at least one packet of the plurality of packets associated with the first traffic class.

The device can be configured to determine, the processing level of the one or more processors is equal to or greater than a processing threshold of the device and select, using a prioritization algorithm, the one or more packets of the plurality of packets to drop. The device can be configured to determine that the processing level of the one or more processors is less than a processing threshold of the device. The device can be configured to stop dropping of the one or more packets of the plurality of packets. The device can be configured to process the one or more packets at the device.

In at least one aspect, a non-transitory computer readable medium is provided. The non-transitory computer readable medium can store program instructions for causing one or more processors to establish a priority level for each traffic class of a plurality of traffic classes. The instructions can cause the one or more processors to receive a plurality of packets. The instructions can cause the one or more processors to determine a processing level of the one or more processors of a device prior to processing the plurality of packets. The instructions can cause the one or more processors to select one or more packets of the plurality of packets to drop responsive to the priority level of one or more traffic classes associated with the one or more packets and the processing level of the one or more processors.

In embodiments, the instructions can cause the one or more processors to assign a first priority level to a first traffic class corresponding to a group of applications packaged in a container. The instructions can cause the one or more processors to assign a second priority level to a second traffic class, the second traffic class different from the first traffic class. The instructions can cause the one or more processors to determine to process a first packet associated with the first traffic based on the first priority level of the first traffic class.

### BRIEF DESCRIPTION OF THE DRAWING FIGURES

Objects, aspects, features, and advantages of embodiments disclosed herein will become more fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, emphasis instead being placed upon illustrating embodiments, principles and concepts. The drawings are not intended to limit the scope of the claims included herewith.

FIG. 1A is a block diagram of a network computing system, in accordance with an illustrative embodiment;

FIG. 1B is a block diagram of a network computing system for delivering a computing environment from a server to a client via an appliance, in accordance with an illustrative embodiment;

FIG. 1C is a block diagram of a computing device, in accordance with an illustrative embodiment;

FIG. 2 is a block diagram of an appliance for processing communications between a client and a server, in accordance with an illustrative embodiment;

FIG. 3 is a block diagram of a virtualization environment, in accordance with an illustrative embodiment;

FIG. 4A is a block diagram of a service graph based system, in accordance with an illustrative embodiment;

FIG. 4B is a block diagram of a service graph, in accordance with an illustrative embodiment;

FIG. 4C is a flow diagram of a method of using a service graph, in accordance with an illustrative embodiment;

FIG. 5A is a block diagram of a system for CPU and priority based early drop packet processing, in accordance with an illustrative embodiment;

FIG. 5B is a graph comparing a ratio of dropped packets to transmitted packets as a function of a CPU usage percentage, in accordance with an illustrative embodiment; and

FIGS. 6A-6B are a flow diagram of a method for CPU and priority based early drop packet processing, in accordance with an illustrative embodiment.

The features and advantages of the present solution will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

For purposes of reading the description of the various embodiments below, the following descriptions of the sections of the specification and their respective contents may be helpful:

Section A describes a network environment and computing environment which may be useful for practicing embodiments described herein;

Section B describes embodiments of systems and methods for delivering a computing environment to a remote user;

Section C describes embodiments of systems and methods for virtualizing an application delivery controller;

Section D describes implementation of systems and methods for a service graph based platform and technology; and

Section E describes embodiments of systems and methods for CPU and priority based early drop packet processing.

### A. Network and Computing Environment

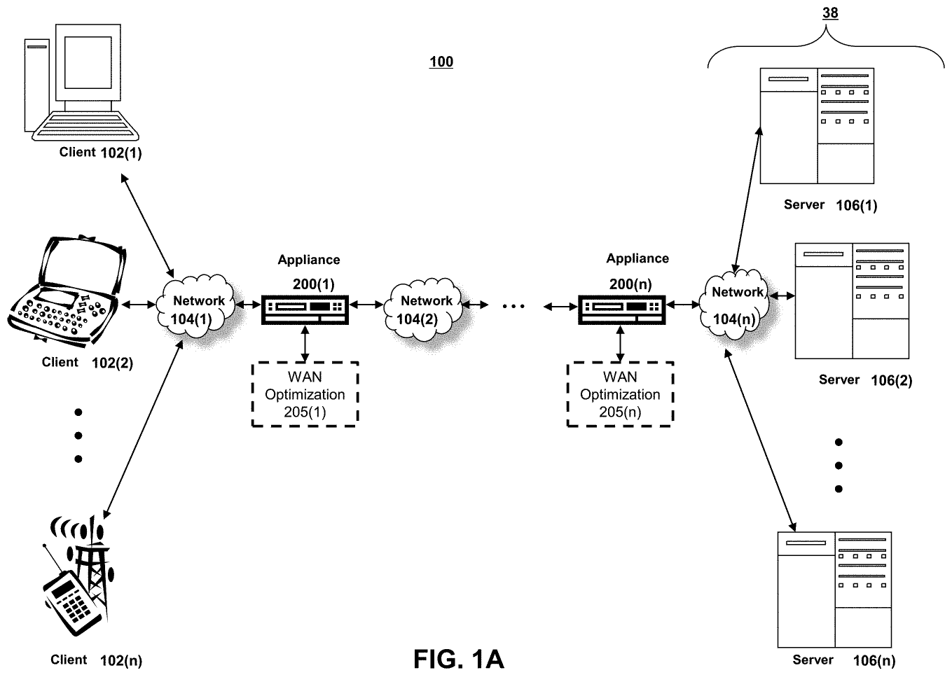

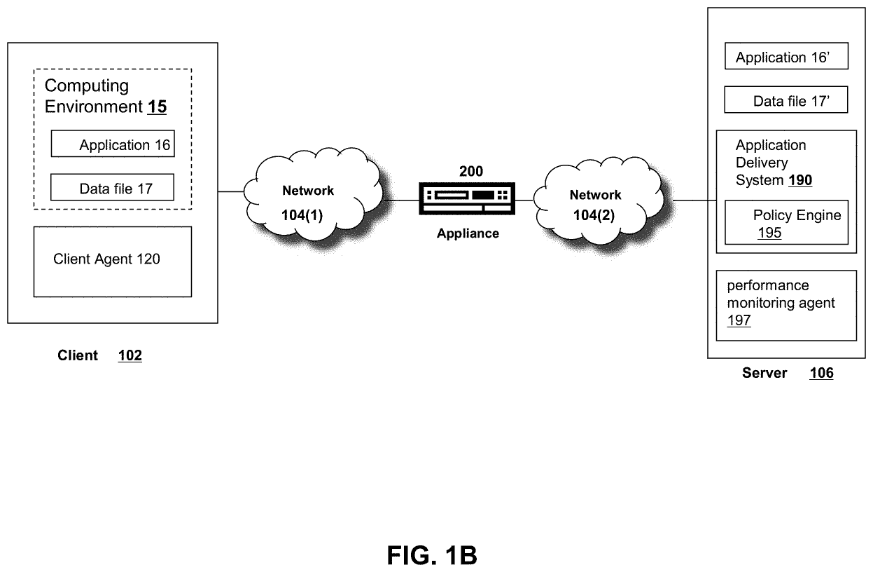

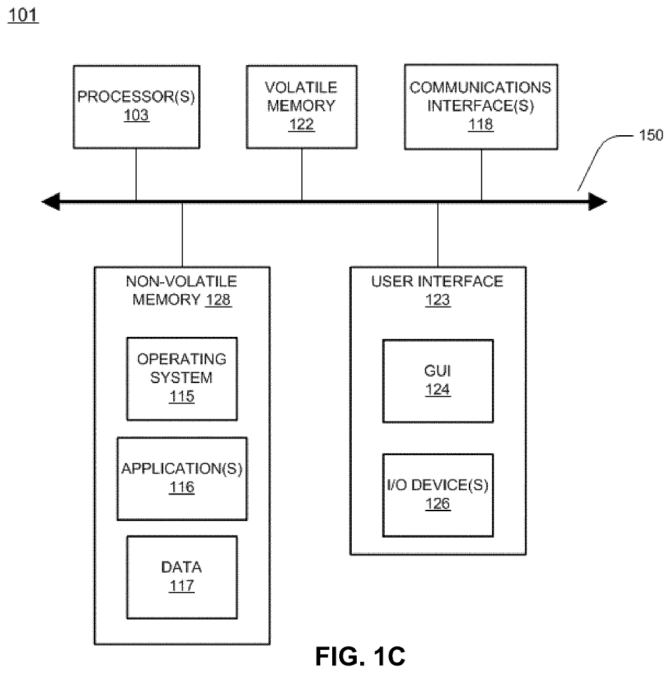

Referring to FIG. 1A, an illustrative network environment 100 is depicted. Network environment 100 may include one or more clients 102(1)-102(n) (also generally referred to as local machine(s) 102 or client(s) 102) in communication with one or more servers 106(1)-106(n) (also generally referred to as remote machine(s) 106 or server(s) 106) via one or more networks 104(1)-104n (generally referred to as network(s) 104). In some embodiments, a client 102 may communicate with a server 106 via one or more appliances 200(1)-200n (generally referred to as appliance(s) 200 or gateway(s) 200).

Although the embodiment shown in FIG. 1A shows one or more networks 104 between clients 102 and servers 106, in other embodiments, clients 102 and servers 106 may be on the same network 104. The various networks 104 may be the same type of network or different types of networks. For example, in some embodiments, network 104(1) may be a private network such as a local area network (LAN) or a company Intranet, while network 104(2) and/or network 104(n) may be a public network, such as a wide area network (WAN) or the Internet. In other embodiments, both network 104(1) and network 104(n) may be private networks. Networks 104 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols.

As shown in FIG. 1A, one or more appliances 200 may be located at various points or in various communication paths of network environment 100. For example, appliance 200 may be deployed between two networks 104(1) and 104(2), and appliances 200 may communicate with one another to work in conjunction to, for example, accelerate network traffic between clients 102 and servers 106. In other embodiments, the appliance 200 may be located on a network 104. For example, appliance 200 may be implemented as part of one of clients 102 and/or servers 106. In an embodiment, appliance 200 may be implemented as a network device such as Citrix networking (formerly NetScaler®) products sold by Citrix Systems, Inc. of Fort Lauderdale, Fla.

As shown in FIG. 1A, one or more servers 106 may operate as a server farm 38. Servers 106 of server farm 38 may be logically grouped, and may either be geographically co-located (e.g., on premises) or geographically dispersed (e.g., cloud based) from clients 102 and/or other servers 106. In an embodiment, server farm 38 executes one or more applications on behalf of one or more of clients 102 (e.g., as an application server), although other uses are possible, such as a file server, gateway server, proxy server, or other similar server uses. Clients 102 may seek access to hosted applications on servers 106.

As shown in FIG. 1A, in some embodiments, appliances 200 may include, be replaced by, or be in communication with, one or more additional appliances, such as WAN optimization appliances 205(1)-205(n), referred to generally as WAN optimization appliance(s) 205. For example, WAN optimization appliance 205 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, appliance 205 may be a performance enhancing proxy or a WAN optimization controller. In one embodiment, appliance 205 may be implemented as Citrix SD-WAN products sold by Citrix Systems, Inc. of Fort Lauderdale, Fla.

Referring to FIG. 1B, an example network environment, 100′, for delivering and/or operating a computing network environment on a client 102 is shown. As shown in FIG. 1B, a server 106 may include an application delivery system 190 for delivering a computing environment, application, and/or data files to one or more clients 102. Client 102 may include client agent 120 and computing environment 15. Computing environment 15 may execute or operate an application, 16, that accesses, processes or uses a data file 17. Computing environment 15, application 16 and/or data file 17 may be delivered via appliance 200 and/or the server 106.

Appliance 200 may accelerate delivery of all or a portion of computing environment 15 to a client 102, for example by the application delivery system 190. For example, appliance 200 may accelerate delivery of a streaming application and data file processable by the application from a data center to a remote user location by accelerating transport layer traffic between a client 102 and a server 106. Such acceleration may be provided by one or more techniques, such as: 1) transport layer connection pooling, 2) transport layer connection multiplexing, 3) transport control protocol buffering, 4) compression, 5) caching, or other techniques. Appliance 200 may also provide load balancing of servers 106 to process requests from clients 102, act as a proxy or access server to provide access to the one or more servers 106, provide security and/or act as a firewall between a client 102 and a server 106, provide Domain Name Service (DNS) resolution, provide one or more virtual servers or virtual internet protocol servers, and/or provide a secure virtual private network (VPN) connection from a client 102 to a server 106, such as a secure socket layer (SSL) VPN connection and/or provide encryption and decryption operations.

Application delivery management system 190 may deliver computing environment 15 to a user (e.g., client 102), remote or otherwise, based on authentication and authorization policies applied by policy engine 195. A remote user may obtain a computing environment and access to server stored applications and data files from any network-connected device (e.g., client 102). For example, appliance 200 may request an application and data file from server 106. In response to the request, application delivery system 190 and/or server 106 may deliver the application and data file to client 102, for example via an application stream to operate in computing environment 15 on client 102, or via a remote-display protocol or otherwise via remote-based or server-based computing. In an embodiment, application delivery system 190 may be implemented as any portion of the Citrix Workspace Suite™ by Citrix Systems, Inc., such as Citrix Virtual Apps and Desktops (formerly XenApp® and XenDesktop®).

Policy engine 195 may control and manage the access to, and execution and delivery of, applications. For example, policy engine 195 may determine the one or more applications a user or client 102 may access and/or how the application should be delivered to the user or client 102, such as a server-based computing, streaming or delivering the application locally to the client 120 for local execution.

For example, in operation, a client 102 may request execution of an application (e.g., application 16′) and application delivery system 190 of server 106 determines how to execute application 16′, for example based upon credentials received from client 102 and a user policy applied by policy engine 195 associated with the credentials. For example, application delivery system 190 may enable client 102 to receive application-output data generated by execution of the application on a server 106, may enable client 102 to execute the application locally after receiving the application from server 106, or may stream the application via network 104 to client 102. For example, in some embodiments, the application may be a server-based or a remote-based application executed on server 106 on behalf of client 102. Server 106 may display output to client 102 using a thin-client or remote-display protocol, such as the Independent Computing Architecture (ICA) protocol by Citrix Systems, Inc. of Fort Lauderdale, Fla. The application may be any application related to real-time data communications, such as applications for streaming graphics, streaming video and/or audio or other data, delivery of remote desktops or workspaces or hosted services or applications, for example infrastructure as a service (IaaS), desktop as a service (DaaS), workspace as a service (WaaS), software as a service (SaaS) or platform as a service (PaaS).

One or more of servers 106 may include a performance monitoring service or agent 197. In some embodiments, a dedicated one or more servers 106 may be employed to perform performance monitoring. Performance monitoring may be performed using data collection, aggregation, analysis, management and reporting, for example by software, hardware or a combination thereof. Performance monitoring may include one or more agents for performing monitoring, measurement and data collection activities on clients 102 (e.g., client agent 120), servers 106 (e.g., agent 197) or an appliance 200 and/or 205 (agent not shown). In general, monitoring agents (e.g., 120 and/or 197) execute transparently (e.g., in the background) to any application and/or user of the device. In some embodiments, monitoring agent 197 includes any of the product embodiments referred to as Citrix Analytics or Citrix Application Delivery Management by Citrix Systems, Inc. of Fort Lauderdale, Fla.

The monitoring agents 120 and 197 may monitor, measure, collect, and/or analyze data on a predetermined frequency, based upon an occurrence of given event(s), or in real time during operation of network environment 100. The monitoring agents may monitor resource consumption and/or performance of hardware, software, and/or communications resources of clients 102, networks 104, appliances 200 and/or 205, and/or servers 106. For example, network connections such as a transport layer connection, network latency, bandwidth utilization, end-user response times, application usage and performance, session connections to an application, cache usage, memory usage, processor usage, storage usage, database transactions, client and/or server utilization, active users, duration of user activity, application crashes, errors, or hangs, the time required to log-in to an application, a server, or the application delivery system, and/or other performance conditions and metrics may be monitored.

The monitoring agents 120 and 197 may provide application performance management for application delivery system 190. For example, based upon one or more monitored performance conditions or metrics, application delivery system 190 may be dynamically adjusted, for example periodically or in real-time, to optimize application delivery by servers 106 to clients 102 based upon network environment performance and conditions.

In described embodiments, clients 102, servers 106, and appliances 200 and 205 may be deployed as and/or executed on any type and form of computing device, such as any desktop computer, laptop computer, or mobile device capable of communication over at least one network and performing the operations described herein. For example, clients 102, servers 106 and/or appliances 200 and 205 may each correspond to one computer, a plurality of computers, or a network of distributed computers such as computer 101 shown in FIG. 1C.

As shown in FIG. 1C, computer 101 may include one or more processors 103, volatile memory 122 (e.g., RAM), non-volatile memory 128 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 123, one or more communications interfaces 118, and communication bus 150. User interface 123 may include graphical user interface (GUI) 124 (e.g., a touchscreen, a display, etc.) and one or more input/output (I/O) devices 126 (e.g., a mouse, a keyboard, etc.). Non-volatile memory 128 stores operating system 115, one or more applications 116, and data 117 such that, for example, computer instructions of operating system 115 and/or applications 116 are executed by processor(s) 103 out of volatile memory 122. Data may be entered using an input device of GUI 124 or received from I/O device(s) 126. Various elements of computer 101 may communicate via communication bus 150. Computer 101 as shown in FIG. 1C is shown merely as an example, as clients 102, servers 106 and/or appliances 200 and 205 may be implemented by any computing or processing environment and with any type of machine or set of machines that may have suitable hardware and/or software capable of operating as described herein.

Processor(s) 103 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

Communications interfaces 118 may include one or more interfaces to enable computer 101 to access a computer network such as a LAN, a WAN, or the Internet through a variety of wired and/or wireless or cellular connections.

In described embodiments, a first computing device 101 may execute an application on behalf of a user of a client computing device (e.g., a client 102), may execute a virtual machine, which provides an execution session within which applications execute on behalf of a user or a client computing device (e.g., a client 102), such as a hosted desktop session, may execute a terminal services session to provide a hosted desktop environment, or may provide access to a computing environment including one or more of: one or more applications, one or more desktop applications, and one or more desktop sessions in which one or more applications may execute.

### B. Appliance Architecture

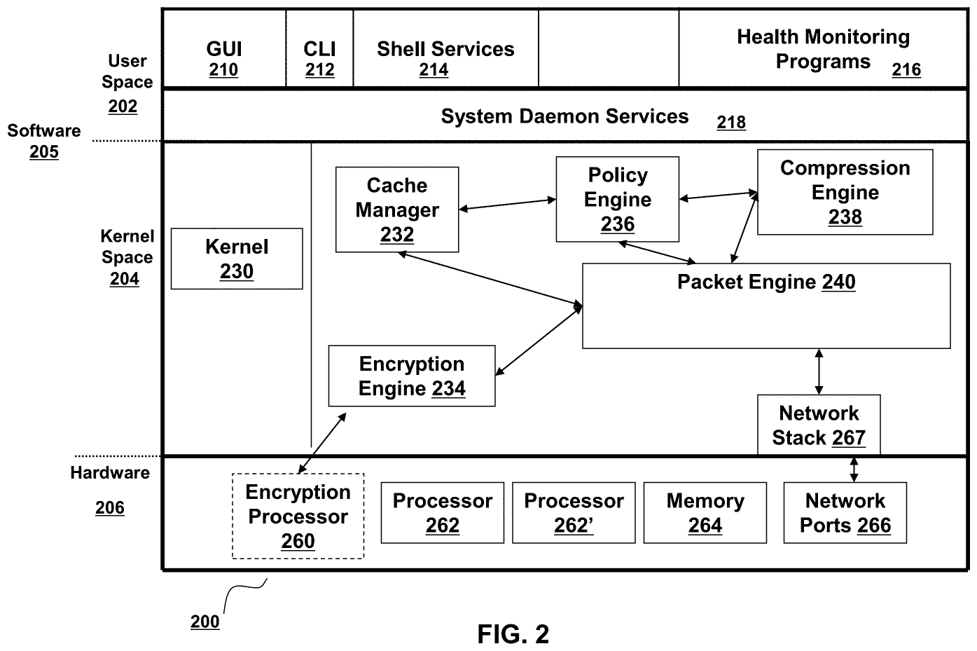

FIG. 2 shows an example embodiment of appliance 200. As described herein, appliance 200 may be implemented as a server, gateway, router, switch, bridge or other type of computing or network device. As shown in FIG. 2, an embodiment of appliance 200 may include a hardware layer 206 and a software layer 205 divided into a user space 202 and a kernel space 204. Hardware layer 206 provides the hardware elements upon which programs and services within kernel space 204 and user space 202 are executed and allow programs and services within kernel space 204 and user space 202 to communicate data both internally and externally with respect to appliance 200. As shown in FIG. 2, hardware layer 206 may include one or more processing units 262 for executing software programs and services, memory 264 for storing software and data, network ports 266 for transmitting and receiving data over a network, and encryption processor 260 for encrypting and decrypting data such as in relation to Secure Socket Layer (SSL) or Transport Layer Security (TLS) processing of data transmitted and received over the network.

An operating system of appliance 200 allocates, manages, or otherwise segregates the available system memory into kernel space 204 and user space 202. Kernel space 204 is reserved for running kernel 230, including any device drivers, kernel extensions or other kernel related software. As known to those skilled in the art, kernel 230 is the core of the operating system, and provides access, control, and management of resources and hardware-related elements of application 104. Kernel space 204 may also include a number of network services or processes working in conjunction with cache manager 232.

Appliance 200 may include one or more network stacks 267, such as a TCP/IP based stack, for communicating with client(s) 102, server(s) 106, network(s) 104, and/or other appliances 200 or 205. For example, appliance 200 may establish and/or terminate one or more transport layer connections between clients 102 and servers 106. Each network stack 267 may include a buffer 243 for queuing one or more network packets for transmission by appliance 200.

Kernel space 204 may include cache manager 232, packet engine 240, encryption engine 234, policy engine 236 and compression engine 238. In other words, one or more of processes 232, 240, 234, 236 and 238 run in the core address space of the operating system of appliance 200, which may reduce the number of data transactions to and from the memory and/or context switches between kernel mode and user mode, for example since data obtained in kernel mode may not need to be passed or copied to a user process, thread or user level data structure.

Cache manager 232 may duplicate original data stored elsewhere or data previously computed, generated or transmitted to reducing the access time of the data. In some embodiments, the cache memory may be a data object in memory 264 of appliance 200, or may be a physical memory having a faster access time than memory 264.

Policy engine 236 may include a statistical engine or other configuration mechanism to allow a user to identify, specify, define or configure a caching policy and access, control and management of objects, data or content being cached by appliance 200, and define or configure security, network traffic, network access, compression or other functions performed by appliance 200.

Encryption engine 234 may process any security related protocol, such as SSL or TLS. For example, encryption engine 234 may encrypt and decrypt network packets, or any portion thereof, communicated via appliance 200, may setup or establish SSL, TLS or other secure connections, for example between client 102, server 106, and/or other appliances 200 or 205. In some embodiments, encryption engine 234 may use a tunneling protocol to provide a VPN between a client 102 and a server 106. In some embodiments, encryption engine 234 is in communication with encryption processor 260. Compression engine 238 compresses network packets bi-directionally between clients 102 and servers 106 and/or between one or more appliances 200.

Packet engine 240 may manage kernel-level processing of packets received and transmitted by appliance 200 via network stacks 267 to send and receive network packets via network ports 266. Packet engine 240 may operate in conjunction with encryption engine 234, cache manager 232, policy engine 236 and compression engine 238, for example to perform encryption/decryption, traffic management such as request-level content switching and request-level cache redirection, and compression and decompression of data.

User space 202 is a memory area or portion of the operating system used by user mode applications or programs otherwise running in user mode. A user mode application may not access kernel space 204 directly and uses service calls in order to access kernel services. User space 202 may include graphical user interface (GUI) 210, a command line interface (CLI) 212, shell services 214, health monitor 216, and daemon services 218. GUI 210 and CLI 212 enable a system administrator or other user to interact with and control the operation of appliance 200, such as via the operating system of appliance 200. Shell services 214 include the programs, services, tasks, processes or executable instructions to support interaction with appliance 200 by a user via the GUI 210 and/or CLI 212.

Health monitor 216 monitors, checks, reports and ensures that network systems are functioning properly and that users are receiving requested content over a network, for example by monitoring activity of appliance 200. In some embodiments, health monitor 216 intercepts and inspects any network traffic passed via appliance 200. For example, health monitor 216 may interface with one or more of encryption engine 234, cache manager 232, policy engine 236, compression engine 238, packet engine 240, daemon services 218, and shell services 214 to determine a state, status, operating condition, or health of any portion of the appliance 200. Further, health monitor 216 may determine if a program, process, service or task is active and currently running, check status, error or history logs provided by any program, process, service or task to determine any condition, status or error with any portion of appliance 200. Additionally, health monitor 216 may measure and monitor the performance of any application, program, process, service, task or thread executing on appliance 200.

Daemon services 218 are programs that run continuously or in the background and handle periodic service requests received by appliance 200. In some embodiments, a daemon service may forward the requests to other programs or processes, such as another daemon service 218 as appropriate.

As described herein, appliance 200 may relieve servers 106 of much of the processing load caused by repeatedly opening and closing transport layer connections to clients 102 by opening one or more transport layer connections with each server 106 and maintaining these connections to allow repeated data accesses by clients via the Internet (e.g., “connection pooling”). To perform connection pooling, appliance 200 may translate or multiplex communications by modifying sequence numbers and acknowledgment numbers at the transport layer protocol level (e.g., “connection multiplexing”). Appliance 200 may also provide switching or load balancing for communications between the client 102 and server 106.

As described herein, each client 102 may include client agent 120 for establishing and exchanging communications with appliance 200 and/or server 106 via a network 104. Client 102 may have installed and/or execute one or more applications that are in communication with network 104. Client agent 120 may intercept network communications from a network stack used by the one or more applications. For example, client agent 120 may intercept a network communication at any point in a network stack and redirect the network communication to a destination desired, managed or controlled by client agent 120, for example to intercept and redirect a transport layer connection to an IP address and port controlled or managed by client agent 120. Thus, client agent 120 may transparently intercept any protocol layer below the transport layer, such as the network layer, and any protocol layer above the transport layer, such as the session, presentation or application layers. Client agent 120 can interface with the transport layer to secure, optimize, accelerate, route or load-balance any communications provided via any protocol carried by the transport layer.

In some embodiments, client agent 120 is implemented as an Independent Computing Architecture (ICA) client developed by Citrix Systems, Inc. of Fort Lauderdale, Fla. Client agent 120 may perform acceleration, streaming, monitoring, and/or other operations. For example, client agent 120 may accelerate streaming an application from a server 106 to a client 102. Client agent 120 may also perform end-point detection/scanning and collect end-point information about client 102 for appliance 200 and/or server 106. Appliance 200 and/or server 106 may use the collected information to determine and provide access, authentication and authorization control of the client's connection to network 104. For example, client agent 120 may identify and determine one or more client-side attributes, such as: the operating system and/or a version of an operating system, a service pack of the operating system, a running service, a running process, a file, presence or versions of various applications of the client, such as antivirus, firewall, security, and/or other software.

### C. Systems and Methods for Providing Virtualized Application Delivery Controller

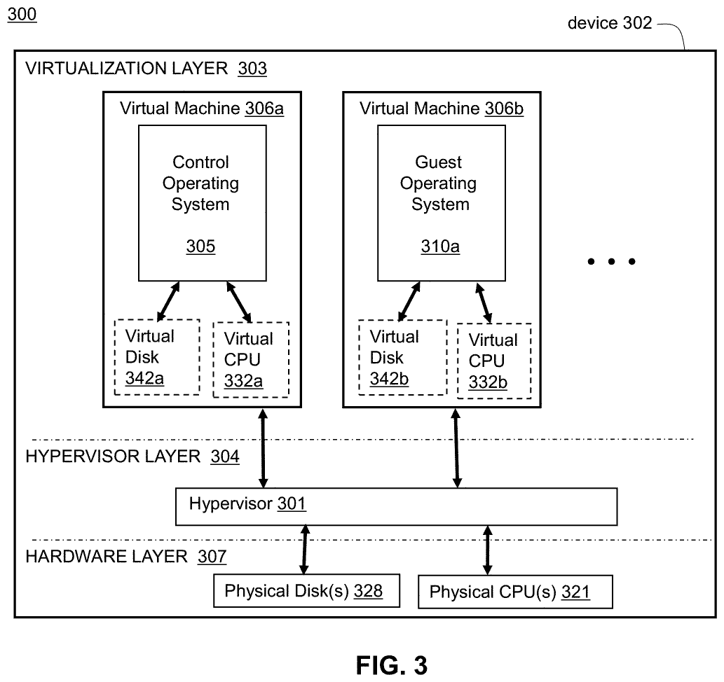

Referring now to FIG. 3, a block diagram of a virtualized environment 300 is shown. As shown, a computing device 302 in virtualized environment 300 includes a virtualization layer 303, a hypervisor layer 304, and a hardware layer 307. Hypervisor layer 304 includes one or more hypervisors (or virtualization managers) 301 that allocates and manages access to a number of physical resources in hardware layer 307 (e.g., physical processor(s) 321 and physical disk(s) 328) by at least one virtual machine (VM) (e.g., one of VMs 306) executing in virtualization layer 303. Each VM 306 may include allocated virtual resources such as virtual processors 332 and/or virtual disks 342, as well as virtual resources such as virtual memory and virtual network interfaces. In some embodiments, at least one of VMs 306 may include a control operating system (e.g., 305) in communication with hypervisor 301 and used to execute applications for managing and configuring other VMs (e.g., guest operating systems 310) on device 302.

In general, hypervisor(s) 301 may provide virtual resources to an operating system of VMs 306 in any manner that simulates the operating system having access to a physical device. Thus, hypervisor(s) 301 may be used to emulate virtual hardware, partition physical hardware, virtualize physical hardware, and execute virtual machines that provide access to computing environments. In an illustrative embodiment, hypervisor(s) 301 may be implemented as a Citrix Hypervisor by Citrix Systems, Inc. of Fort Lauderdale, Fla. In an illustrative embodiment, device 302 executing a hypervisor that creates a virtual machine platform on which guest operating systems may execute is referred to as a host server. 302

Hypervisor 301 may create one or more VMs 306 in which an operating system (e.g., control operating system 305 and/or guest operating system 310) executes. For example, the hypervisor 301 loads a virtual machine image to create VMs 306 to execute an operating system. Hypervisor 301 may present VMs 306 with an abstraction of hardware layer 307, and/or may control how physical capabilities of hardware layer 307 are presented to VMs 306. For example, hypervisor(s) 301 may manage a pool of resources distributed across multiple physical computing devices.

In some embodiments, one of VMs 306 (e.g., the VM executing control operating system 305) may manage and configure other of VMs 306, for example by managing the execution and/or termination of a VM and/or managing allocation of virtual resources to a VM. In various embodiments, VMs may communicate with hypervisor(s) 301 and/or other VMs via, for example, one or more Application Programming Interfaces (APIs), shared memory, and/or other techniques.

In general, VMs 306 may provide a user of device 302 with access to resources within virtualized computing environment 300, for example, one or more programs, applications, documents, files, desktop and/or computing environments, or other resources. In some embodiments, VMs 306 may be implemented as fully virtualized VMs that are not aware that they are virtual machines (e.g., a Hardware Virtual Machine or HVM). In other embodiments, the VM may be aware that it is a virtual machine, and/or the VM may be implemented as a paravirtualized (PV) VM.

Although shown in FIG. 3 as including a single virtualized device 302, virtualized environment 300 may include a plurality of networked devices in a system in which at least one physical host executes a virtual machine. A device on which a VM executes may be referred to as a physical host and/or a host machine. For example, appliance 200 may be additionally or alternatively implemented in a virtualized environment 300 on any computing device, such as a client 102, server 106 or appliance 200. Virtual appliances may provide functionality for availability, performance, health monitoring, caching and compression, connection multiplexing and pooling and/or security processing (e.g., firewall, VPN, encryption/decryption, etc.), similarly as described in regard to appliance 200.

In some embodiments, a server may execute multiple virtual machines 306, for example on various cores of a multi-core processing system and/or various processors of a multiple processor device. For example, although generally shown herein as “processors” (e.g., in FIGS. 1C, 2 and 3), one or more of the processors may be implemented as either single- or multi-core processors to provide a multi-threaded, parallel architecture and/or multi-core architecture. Each processor and/or core may have or use memory that is allocated or assigned for private or local use that is only accessible by that processor/core, and/or may have or use memory that is public or shared and accessible by multiple processors/cores. Such architectures may allow work, task, load or network traffic distribution across one or more processors and/or one or more cores (e.g., by functional parallelism, data parallelism, flow-based data parallelism, etc.).

Further, instead of (or in addition to) the functionality of the cores being implemented in the form of a physical processor/core, such functionality may be implemented in a virtualized environment (e.g., 300) on a client 102, server 106 or appliance 200, such that the functionality may be implemented across multiple devices, such as a cluster of computing devices, a server farm or network of computing devices, etc. The various processors/cores may interface or communicate with each other using a variety of interface techniques, such as core to core messaging, shared memory, kernel APIs, etc.

In embodiments employing multiple processors and/or multiple processor cores, described embodiments may distribute data packets among cores or processors, for example to balance the flows across the cores. For example, packet distribution may be based upon determinations of functions performed by each core, source and destination addresses, and/or whether: a load on the associated core is above a predetermined threshold; the load on the associated core is below a predetermined threshold; the load on the associated core is less than the load on the other cores; or any other metric that can be used to determine where to forward data packets based in part on the amount of load on a processor.

For example, data packets may be distributed among cores or processes using receive-side scaling (RSS) in order to process packets using multiple processors/cores in a network. RSS generally allows packet processing to be balanced across multiple processors/cores while maintaining in-order delivery of the packets. In some embodiments, RSS may use a hashing scheme to determine a core or processor for processing a packet.

The RSS may generate hashes from any type and form of input, such as a sequence of values. This sequence of values can include any portion of the network packet, such as any header, field or payload of network packet, and include any tuples of information associated with a network packet or data flow, such as addresses and ports. The hash result or any portion thereof may be used to identify a processor, core, engine, etc., for distributing a network packet, for example via a hash table, indirection table, or other mapping technique.

Although shown in FIGS. 1A and 1B as being single appliances, appliances 200 may be implemented as one or more distributed or clustered appliances. Individual computing devices or appliances may be referred to as nodes of the cluster. A centralized management system may perform load balancing, distribution, configuration, or other tasks to allow the nodes to operate in conjunction as a single computing system. Such a cluster may be viewed as a single virtual appliance or computing device. A plurality of appliances 200 or other computing devices (e.g., nodes) may be joined into a single cluster. A cluster may operate as an application server, network storage server, backup service, or any other type of computing device to perform many of the functions of appliances 200 and/or 205.

### D. Service Graph Based Platform and Technology

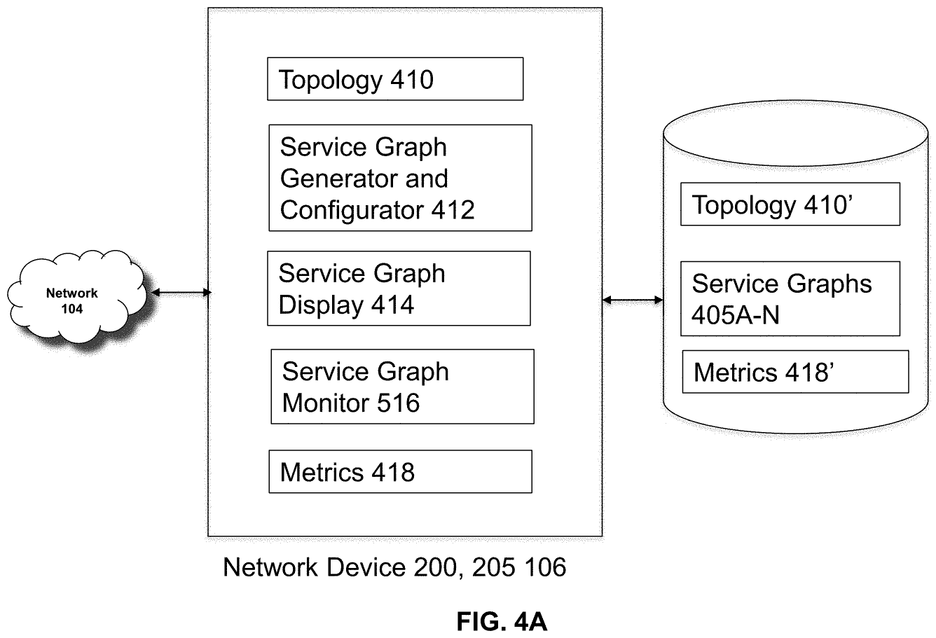

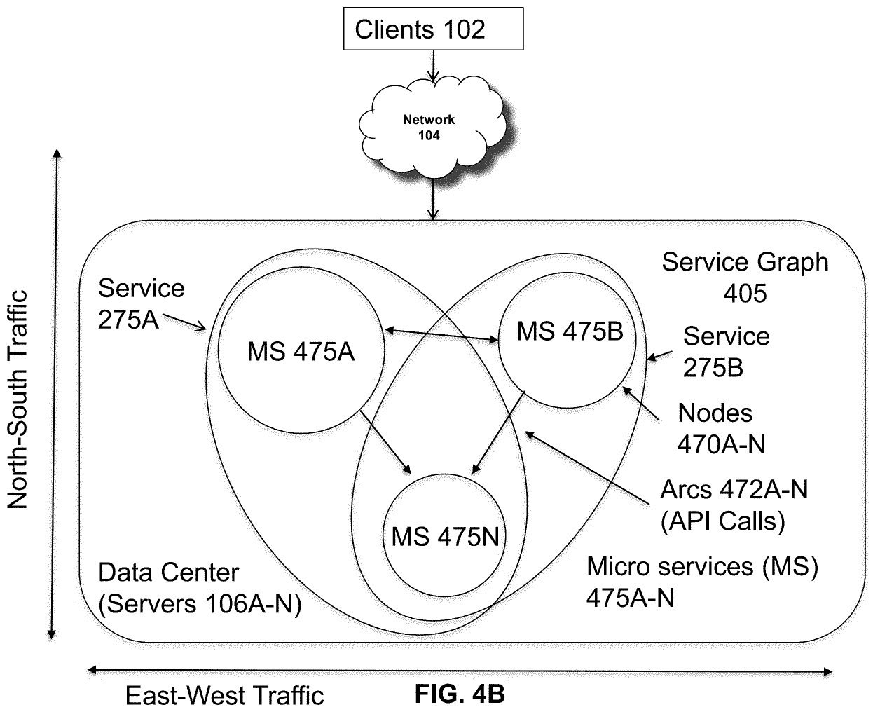

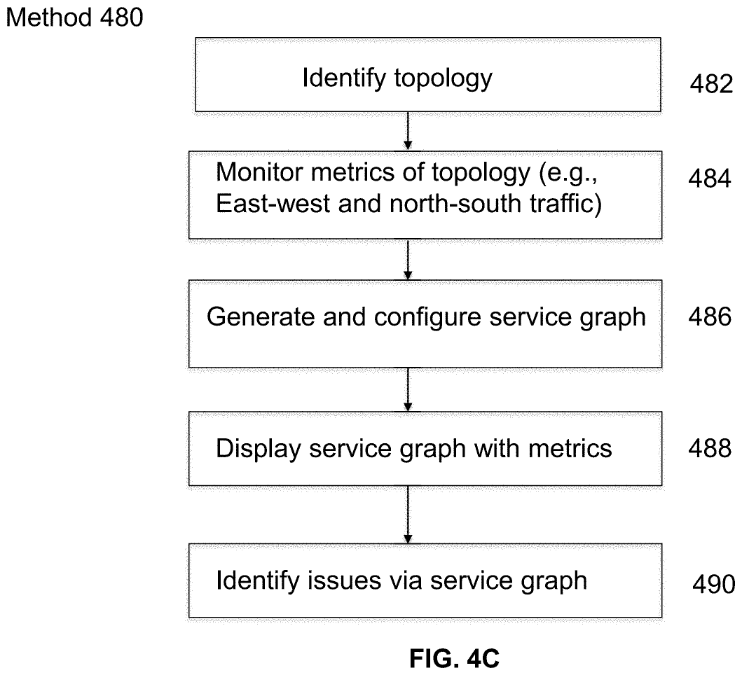

Referring now to FIGS. 4A-4C, implementation of systems and methods for a service graph based platform and technology will be discussed. A service graph is a useful technology tool for visualizing a service by its topology of components and network elements. Services may be made up of microservices with each microservice handling a particular set of one or more functions of the service. Network traffic may traverse the service topology such as a client communicating with a server to access service (e.g., north-south traffic). Network traffic of a service may include network traffic communicated between microservices of the services such as within a data center or between data centers (e.g., east-west traffic). The service graph may be used to identify and provide metrics of such network traffic of the service as well as operation and performance of any network elements used to provide the service. Service graphs may be used for identifying and determining issues with the service and which part of the topology causing the issue. Services graphs may be used to provide for administering, managing and configuring of services to improve operational performance of such services.

Referring to FIG. 4A, an implementation of a system for service graphs, such as those illustrated in FIG. 4B, will be described. A device on a network, such as a network device 200, 205 or a server 206, may include a service graph generator and configurator 412, a service graph display 414 and service graph monitor 416. The service graph generator and configurator 412 (generally referred to as service graph generator 412), may identify a topology 410 of elements in the network and metrics 418 related to the network and the elements, to generate and/or configure service graphs 405A-N. The service graphs 405A-N (generally referred to as service graphs 405) may be stored in one or more databases, with any of the metric 418′ and/or topology 410′. The service graphic generator 412 may generate data of the service graphs 405 to be displayed in a display or rendered form such as via a user interface, generated referred to as service graph display 414. Service graph monitor 416 may monitor the network elements of the topology and service for metrics 418 to configure and generate a service graph 405 and/or to update dynamically or in real-time the elements and metrics 418 of or represented by a service graph display 414.

The topology 410 may include data identifying, describing, specifying or otherwise representing any elements used, traversed in accessing any one or more services or otherwise included with or part of such one or more services, such as any of the services 275 described herein. The topology may include data identifying or describing any one or more networks and network elements traversed to access or use the services, including any network devices, routers, switches, gateways, proxies, appliances, network connections or links, Internet Service Providers (ISPs), etc. The topology may include data identifying or describing any one or more applications, software, programs, services, processes, tasks or functions that are used or traversed in accessing a service. In some implementations, a service may be made up or include multiple microservices, each providing one or more functions, functionality or operations of or for a service. The topology may include data identifying or describing any one or more components of a service, such as programs, functions, applications or microservices used to provide the service. The topology may include parameters, configuration data and/or metadata about any portion of the topology, such as any element of the topology.

A service graph 405 may include data representing the topology of a service 275, such any elements making up such a service or used by the service, for example as illustrated in FIG. 4B. The service graph may be in a node base form, such as graphical form of nodes and each node representing an element or function of the topology of the service. A service graph may represent the topology of a service using nodes connected among each other via various connectors or links, which may be referred to as arcs. The arc may identify a relationship between elements connected by the arc. Nodes and arcs may be arranged in a manner to identify or describe one or more services. Nodes and arcs may be arranged in a manner to identify or describe functions provided by the one or more services. For example, a function node may represent a function that is applied to the traffic, such as a transform (SSL termination, VPN gateway), filter (firewalls), or terminal (intrusion detection systems). A function within the service graph might use one or more parameters and have one or more connectors.

The service graph may include any combination of nodes and arcs to represent a service, topology or portions thereof. Nodes and arcs may be arranged in a manner to identify or describe the physical and/or logical deployment of the service and any elements used to access the service. Nodes and arcs may be arranged in a manner to identify or describe the flow of network traffic in accessing or using a service. Nodes and arcs may be arranged in a manner to identify or describe the components of a service, such as multiple microservices that communicate with each other to provide functionality of the service. The service graph may be stored in storage such as a database in a manner in order for the service graph generator to generate a service graph in memory and/or render the service graph in display form 414.

The service graph generator 412 may include an application, program, library, script, service, process, task or any type and form of executable instructions for establishing, creating, generating, implementing, configuring or updating a service graph 405. The service graph generator may read and/or write data representing the service graph to a database, file or other type of storage. The service graph generator may comprise logic, functions and operations to construct the arrangement of nodes and arcs to have an electronic representation of the service graph in memory. The service graph generator may read or access the data in the database and store data into data structures and memory elements to provide or implement a node based representation of the service graph that can be updated or modified. The service graph generator may use any information from the topology to generate a service graph. The service graph generator may make network calls or use discovery protocols to identify the topology or any portions thereof. The service graph generator may use any metrics, such as in memory or storage or from other devices, to generate a service graph. The service graph generator may comprise logic, functions and operations to construct the arrangement of nodes and arcs to provide a graphical or visual representation of the service graph, such as on a user interface of a display device. The service graph generator may comprise logic, functions and operations to configure any node or arc of the service graph to represent a configuration or parameter of the corresponding or underlying element represented by the node or arc. The service graph generator may comprise logic, functions and operations to include, identify or provide metrics in connection with or as part of the arrangement of nodes and arcs of the service graph display. The service graph generator may comprise an application programming interface (API) for programs, applications, services, tasks, processes or systems to create, modify or interact with a service graph.

The service graph display 414 may include any graphical or electronic representation of a service graph 405 for rendering or display on any type and form of display device. The service graph display may be rendered in visual form to have any type of color, shape, size or other graphical indicators of the nodes and arcs of the service graph to represent a state or status of the respective elements. The service graph display may be rendered in visual form to have any type of color, shape, size or other graphical indicators of the nodes and arcs of the service graph to represent a state or status of one or more metrics. The service graph display may comprise any type of user interface, such as a dashboard, that provides the visual form of the service graph. The service graph display may include any type and form of user interface elements to allow users to interact, interface or manipulate a service graph. Portion of the service graph display may be selectable to identify information, such as metrics or topology information about that portion of the service graph. Portions of the service graph display may provide user interface elements for users to take an action with respect to the service graph or portion thereof, such as to modify a configuration or parameter of the element.

The service graph monitor 418 may include an application, program, library, script, service, process, task or any type and form of executable instructions to receive, identify, process metrics 418 of the topology 410. The service graph monitor 418 monitors via metrics 418 the configuration, performance and operation of elements of a service graph. The service graph monitor may obtain metrics from one or more devices on the network. The service graph monitor may identify or generate metrics from network traffic traversing the device(s) of the service graph monitor. The service graph monitor may receive reports of metrics from any of the elements of the topology, such as any elements represented by a node in the service graph. The service graph monitor may receive reports of metrics from the service. From the metrics, the service graph monitor may determine the state, status or condition of an element represented in or by the service graph, such as by a node of the service graph. From the metrics, the service graph monitor may determine the state, status or condition of network traffic or network connected represented in or by the service graph, such as by an arc of the service graph. The service graph generator and/or service graph monitor may update the service graph display, such as continuously or in predetermined frequencies or event based, with any metrics or any changed in the state, status or condition of a node or arc, element represented by the node or arc, the service, network or network traffic traversing the topology.

The metrics 418, 418′ (generally referred to as metrics 418) may be stored on network device in FIG. 4B, such as in memory or storage. The metrics 418, 418′ may be stored in a database on the same device or over a network to another device, such as a server. Metrics may include any type and form of measurement of any element of the topology, service or network. Metrics may include metrics on volume, rate or timing of requests or responses received, transmitted or traversing the network element represented by the node or arc. A Metrics may include metrics on usage of a resource by the element represented by the node or arc, such as memory, bandwidth. Metrics may include metrics on performance and operation of a service, including any components or microservices of the service, such as rate of response, transaction responses and times.

FIG. 4B illustrates an implementation of a service graph in connection with micro-services of a service in view of east-west network traffic and north-south network traffic. In brief overview, clients 102 may access via one or more networks 104 a data center having servers 106A-106N (generally referred to as servers 106) providing one or more services 275A-275N (generally referred to as services 275). The services may be made up multiple microservices 475A-475N (generally referred to as microservice or micro service 475). Service 275A may include microservice 475A and 475N while service 275B may include microservice 475B and 475N. The microservices may communicate among the microservices via application programming interface (APIs). A service graph 405 may represent a topology of the services and metrics on network traffic, such as east-west network traffic and north-south network traffic.

North-south network traffic generally describes and is related to network traffic between clients and servers, such as client via networks 104 to servers of data center and/or servers to clients via network 104 as shown in FIG. 4B. East-west network traffic generally describes and is related to network traffic between elements in the data centers, such as data center to data center, server to server, service to service or microservice to microservice.

A service 275 may comprise microservices 475. In some aspects, microservices is a form of service-oriented architecture style wherein applications are built as a collection of different smaller services rather than one whole or singular application (referred to sometimes as a monolithic application). Instead of a monolithic application, a service has several independent applications or services (e.g., microservices) that can run on their own and may be created using different coding or programming languages. As such, a larger server can be made up of simpler and independent programs or services that are executable by themselves. These smaller programs or services are grouped together to deliver the functionalities of the larger service. In some aspects, a microservices based service structures an application as a collection of services that may be loosely coupled. The benefit of decomposing a service into different smaller services is that it improves modularity. This makes the application or service easier to understand, develop, test, and be resilient to changes in architecture or deployment.

A microservice includes an implementation of one or more functions or functionality. A microservice may be a self-contained piece of business function(s) with clear or established interfaces, such as an application programming interface (API). In some implementations, a microservice may be deployed in a virtual machine or a container. A service may use one or more functions on one microservice and another one or more functions of a different microservice. In operating or executing a service, one microservice may make API calls to another microservice and the microservice may provide a response via an API call, event handler or other interface mechanism. In operating or executing a microservice, the microservice may make an API call to another microservice, which in its operation or execution, makes a call to another microservice, and so on.

The service graph 405 may include multiple nodes 470A-N connected or linked via one or more or arcs 472A-472N. The service graph may have different types of nodes. A node type may be used to represent a physical network element, such as a server, client, appliance or network device. A node type may be used to represent an end point, such as a client or server. A node type may be used to represent an end point group, such as group of clients or servers. A node type may be used to represent a logical network element, such as a type of technology, software or service or a grouping or sub-grouping of elements. A node type may be used to represent a functional element, such as functionality to be provided by an element of the topology or by the service.

The configuration and/or representation of any of the nodes 470 may identify a state, a status and/or metric(s) of the element represented by the node. Graphical features of the node may identify or specify an operational or performance characteristic of the element represented by the node. A size, color or shape of the node may identify an operational state of whether the element is operational or active. A size, color or shape of the node may identify an error condition or issue with an element. A size, color or shape of the node may identify a level of volume of network traffic, a volume of request or responses received, transmitted or traversing the network element represented by the node. A size, color or shape of the node may identify a level of usage of a resource by the element represented by the node, such as memory, bandwidth, CPU or storage. A size, color or shape of the node may identify relativeness with respect to a threshold for any metric associated with the node or the element represented by the node.

The configuration and/or representation of any of the arcs 472 may identify a state, status and/or metric(s) of the element represented by the arc. Graphical features of the arc may identify or specify an operational or performance characteristic of the element represented by the arc. A size, color or shape of the node may identify an operational state of whether the network connection represented by the arc is operational or active. A size, color or shape of the arc may identify an error condition or issue with a connection associated with the arc. A size, color or shape of the arc may identify an error condition or issue with network traffic associated with the arc. A size, color or shape of the arc may identify a level of volume of network traffic, a volume of request or responses received, transmitted or traversing the network connection or link represented by the arc. A size, color or shape of the arc may identify a level of usage of a resource by network connection or traffic represented by the arc, such as bandwidth. A size, color or shape of the node may identify relativeness with respect to a threshold for any metric associated with the arc. In some implementations, a metric for the arc may include any measurement of traffic volume per arc, latency per arc or error rate per arc.

Referring now to FIG. 4C, an implementation of a method for generating and displaying a service graph will be described. In brief overview of method 480, at step 482, a topology is identified, such as for a configuration of one or more services. At step 484, the metrics of elements of the topology, such as for a service are monitored. At step 486, a service graph is generated and configured. At step 488, a service graph is displayed. At step 490, issues with configuration, operation and performance of a service or the topology may be identified or determined.

At step 482, a device identifies a topology for one or more services. The device may obtain, access or receive the topology 410 from storage, such as a database. The device may be configured with a topology for a service, such as by a user. The device may discover the topology or portions therefore via one more discovery protocols communicated over the network. The device may obtain or receive the topology or portions thereof from one or more other devices via the network. The device may identify the network elements making up one or more services. The device may identify functions providing the one or more services. The device may identify other devices or network elements providing the functions. The device may identify the network elements for north-west traffic. The device may identify the network elements for east-west traffic. The device may identify the microservices providing a service. In some implementations, the service graph generator establishes or generates a service graph based on the topology. The service graph may be stored to memory or storage.

At step 484, the metrics of elements of the topology, such as for a service are monitored. The device may receive metrics about the one or more network elements of the topology from other devices. The device may determine metrics from network traffic traversing the device. The device may receive metrics from network elements of the topology, such as via reports or events. The device may monitor the service to obtain or receive metrics about the service. The metrics may be stored in memory or storage, such as in association with a corresponding service graph. The device may associate one or more of the metrics with a corresponding node of a service graph. The device may associate one or more of the metrics with a corresponding arc of a service graph. The device may monitor and/or obtain and/or receive metrics on a scheduled or predetermined frequency. The device may monitor and/or obtain and/or receive metrics on a continuous basis, such as in real-time or dynamically when metrics change.

At step 486, a service graph is generated and configured. A service graph generator may generate a service graph based at least on the topology. A service graph generator may generate a service graph based at least on a service. A service graph generator may generate a service graph based on multiple services. A service graph generator may generate a service graph based at least on the microservices making up a service. A service graph generator may generate a service graph based on a data center, servers of the data center and/or services of the data center. A service graph generator may generate a service graph based at least on east-west traffic and corresponding network elements. A service graph generator may generate a service graph based at least on north-south traffic and corresponding network elements. A service graph generator may configure the service graph with parameters, configuration data or meta-data about the elements represented by a node or arc of the service graph. The service graph may be generated automatically by the device. The service graph may be generated responsive to a request by a user, such as via a comment to or user interface of the device.

At step 488, a service graph is displayed. The device, such as via service graph generator, may create a service graph display 414 to be displayed or rendered via a display device, such as presented on a user interface. The service graph display may include visual indicators or graphical characteristics (e.g., size, shape or color) of the nodes and arcs of the service graph to identify status, state or condition of elements associated with or corresponding to a node or arc. The service graph display may be displayed or presented via a dashboard or other user interface in which a user may monitor the status of the service and topology. The service graph display may be updated to show changes in metrics or the status, state and/or condition of the service, the topology or any elements thereof. Via the service graph display, a user may interface or interact with the service graph to discover information, data and details about any of the network elements, such as the metrics of a microservice of a service.

At step 490, issues with configuration, operation and performance of a service or the topology may be identified or determined. The device may determine issues with the configuration, operation or performance of a service by comparing metrics of the service to thresholds. The device may determine issues with the configuration, operation or performance of a service by comparing metrics of the service to previous or historical values. The device may determine issues with the configuration, operation or performance of a service by identifying a change in a metric. The device may determine issues with the configuration, operation or performance of a service by identifying a change in a status, state or condition of a node or arc or elements represented by the node or arc. The device may change the configuration and/or parameters of the service graph. The device may change the configuration of the service. The device may change the configuration of the topology. The device may change the configuration of network elements making up the topology or the service. A user may determine issues with the configuration, operation or performance of a service by reviewing, exploring or interacting with the service graph display and any metrics. The user may change the configuration and/or parameters of the service graph. The user may change the configuration of the service. The user may change the configuration of the topology. The device may change the configuration of network elements making up the topology or the service.

### E. CPU and Priority Based Early Drop Packet Processing

The present disclosure is directed towards central processing unit (CPU) load and priority based early drop packet processing. In embodiments, a device can determine to drop or process a packet prior to processing the packet based in part on a processing load level and/or a priority of the packet. The device can determine to drop a portion of packets when the processing level of one or more processors of the device is at or within a defined range of a processing threshold of the device. The device can determine to process or drop packets based in part on a priority level of a traffic class associated with the respective packets when the processing level of one or more processors of the device is at or within a defined range of a processing threshold of the device. The device can prioritize traffic to protect high priority traffic and maintain user experience during periods of high CPU usage (e.g., processing level at or greater than a processing threshold). For example, the device can determine to drop packets corresponding to low priority traffic when a CPU load level reaches a processing threshold level and process packets corresponding to high priority traffic. The priority based drop selection can be used to reduce a current CPU usage level and protect against different forms of external attacks.

In embodiments, services and applications can be containerized or encapsulated in a container having its own operating system. A device can receive a plurality of packets intended for or associated with the containerized applications and process and provide the packets to the respective containerized applications. However, the oversubscription of containers or applications that consume high CPU processing can cause or result in service disruption and/or degradation of user experience. The CPU load at the device can increase over a processing level threshold resulting in slow response times, failures and/or service disruptions. The emergence of large cluster systems and the usage of automated orchestration systems (e.g., kubernetes (k8)) can make it more difficult to identify service disruptions and degradation issues, particularly if these issues occur temporarily or sporadically. The systems and methods described herein provide for a device (e.g., packet engine) to make a determination to drop or process packets upon receiving the packet based in part on a CPU load level of one or more processors of the device and/or a priority of the packet. The device can drop packets when the CPU load level is over a threshold level to reduce the CPU load level or maintain the CPU load level below the threshold and protect or provide an improved user experience. The device can protect high-priority packet traffic by determining a priority level of the received packets, dropping those packets corresponding to low priority traffic while processing those packets corresponding to high priority traffic. The device can prioritize high-latency, user-facing traffic to provide a better or improved user experience when the CPU load levels are high or near critical thresholds.

The device can establish a processing threshold indicating a critical load limit when the performance or processing of packets impacts a user experience or quality of service provided by one or more containerized applications, resulting in service disruptions and degradation of user experience. By prioritizing containerized applications, the device (e.g., packet engine) can drop received packets prior to processing. In embodiments, the device can select to drop one or more packets after a critical CPU level is reached (e.g., processing threshold level) and a drop probability can increase as the CPU load at the device increases. The device can select the packets to be dropped based in part on the relative priorities of the corresponding traffic classes that the received packets belong to. In embodiments, clients (e.g., customers) can protect the data of applications they select or flag as high priority applications over other low priority applications (e.g., finance applications given higher priority than logging applications/services).

The device can collect and maintain statistics, for example, CPU usage reports, to modify the priority level of certain applications or containers. In embodiments, the device can use the statistics to de-prioritize one or more containers or applications to drop or lower the CPU usage and maintain an operation level of the system. In embodiments, the device can use the statistics to re-prioritize one or more containers or applications in response to a drop or decrease in the CPU usage of the system. The device can dynamically prioritize containers and/or applications to maintain and protect user experience. In some embodiments, the device can automatically or dynamically modify the priority (e.g., de-prioritize, re-prioritize) types of traffic to protect the system against different types of attacks. For example, in one embodiment, the device can de-prioritize traffic identified as attack traffic or malicious traffic to protect against different forms of attacks (e.g., denial of service (DOS) attacks). Thus, the device can dynamically modify the priority level of different forms of traffic to drop attack traffic when, for example, CPU usage increases to due attacks and protect and process high-priority traffic.

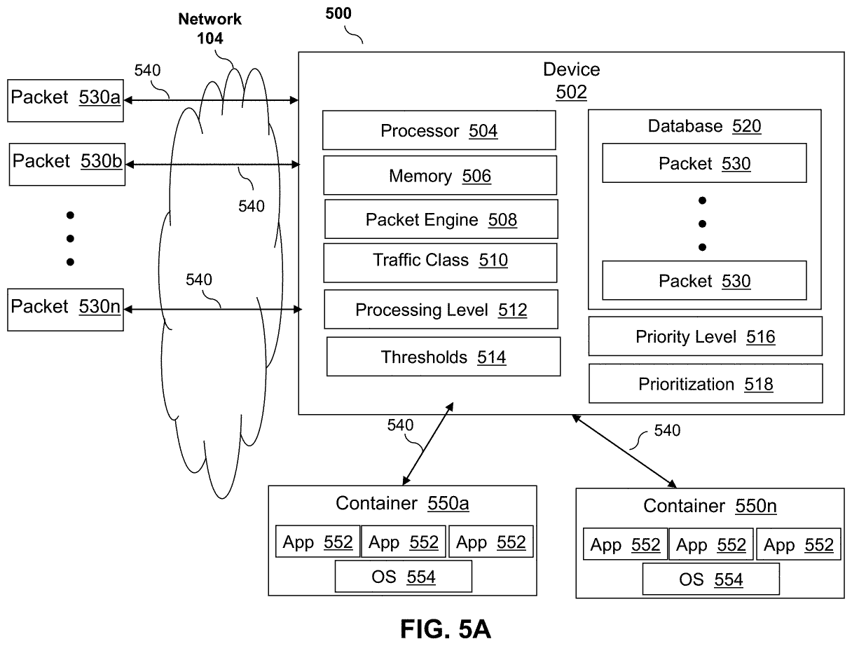

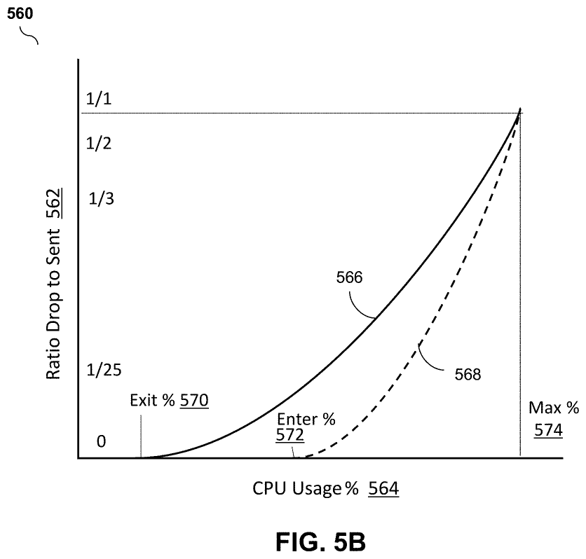

Referring now to FIG. 5A, a system 500 having a device 502 for receiving and determining to drop or process one or more packets 530 is shown. In embodiments, the device 502 can be an intermediary device 502, intermediary to a plurality of clients (e.g., clients 102) and a plurality of containers 550 having a plurality of applications 552 (e.g., containerized applications 552). The device 502 can determine to drop or process a packet 530 based in part in a processing level 512 (e.g., CPU load) of one or more processors 504 of the device 502 and/or a priority level 516 of a traffic class 510 of the packet 530. In embodiments, the device 502 can make a determination to drop or process one or more packets 530 to protect high priority applications, improve user experience, reduce the processing level 512 of the device 502 and/or defend against external (e.g., malicious) attacks.

The device 502 can include a proxy or a gateway to monitor calls and traffic, and route calls and traffic (e.g., packets 530) between a plurality of containers 550. For example, the device 502 can determine to drop a packet 530 prior to processing the packet 530 or determine to process the packet 530. The packets 530 can include, but not limited to, a data packet or network packet. The packets 530 can include, but not limited to, a unit of data or request. The device 502 can include a server. The device 502 can include one or more processors 504 coupled to a memory 506. The processor 504 can include or be coupled to a non-volatile memory 506 that stores computer instructions and an operating system. For example, the computer instructions can be executed by the processor 504 out of volatile memory 506 to perform all or part of the method 600.

The device 502 can be implemented using hardware or a combination of software and hardware. For example, each component of the device 502 can include logical circuitry (e.g., a central processing unit or CPU) that responses to and processes instructions fetched from a memory unit (e.g., memory 506). Each component of the device 502 can include or use a microprocessor or a multi-core processor. A multi-core processor can include two or more processing units on a single computing component. Each component of the device 502 can be based on any of these processors, or any other processor capable of operating as described herein. Each processor can utilize instruction level parallelism, thread level parallelism, different levels of cache, etc. For example, the device 502 can include at least one logic device such as a computing device or server having at least one processor to communicate via a network 104. The components and elements of the device 502 can be separate components or a single component. For example, the device 502 can include combinations of hardware and software, such as one or more processors configured to initiate stop commands, initiate motion commands, and transmit or receive event data, for example. The device 502 can include a structured set of data. For example, the device 502 can include and/or store a plurality of packets 530 and/or metadata associated with the plurality of packets 530.

The device 502 can include a memory component (e.g., memory 506) to store and retrieve data. The memory 506 can include a random access memory (RAM) or other dynamic storage device, coupled with the device 502 for storing information, and instructions to be executed by the device 502. The memory 506 can include at least one read only memory (ROM) or other static storage device coupled with the device 502 for storing static information and instructions for the device 502. The memory 506 can include a storage device, such as a solid state device, magnetic disk or optical disk, coupled with the device 502 to persistently store information and instructions.

The device can manage a plurality of containers 550. The device 502 can process and/or provide one or more packets 530 to the plurality of containers 550. The containers 550 can include a plurality of applications 552. For example, the applications 552 can be packaged or grouped together such that applications 552 in a common container 550 can share an operating system 554, code, configurations and/or dependencies. In embodiments, the containers 550 can package one or more application's code, configurations, and dependencies into a single object for a plurality of applications 552. In embodiments, the applications 552 of a common container 550 can share an operating system 554 installed on a server and run as resource-isolated processes. The device 502 manage a plurality of microservices 475. The plurality of microservices 475 can couple with or otherwise interact with the device 502. In embodiments, the plurality of microservices 475 can be a component of one or more services 275 or applications 552. For example, the microservices 475 can be the same as or substantially similar to microservices 475A-475N described above with respect to FIGS. 4A-4C. For example, two or more microservices 475 can be grouped together or interact with each other to provide the functionality or skills of at least one service 275. The microservices 475 can communicate with one or more other microservices 475 via application programming interface (APIs).

In embodiments, the containers 550 can couple with or receive packets 530 from the device 502 via one or more channels 540. The channels 540 can include a session or connection between the device 502 and at least one container 550 or application 552. In some embodiments, the channels 540 can include a session or connection between two or more applications 552. The channel 540 may include encrypted and/or secure sessions established between the device 502 and at least one container 550, application 552 or between two or more applications 552. The encrypted session can include an encrypted connection between a device 502 and at least one container 550, application 552 or between two or more applications 552.

The device 502 can include a packet engine 508 to perform all or part of method 600. For example, the packet engine 508 can receive one or more packets 530 and make a determination to drop or process the one or more packets 530 based in part on a processing level 512 of one or more processors 504 of the device 502 and/or a priority level 516 of a traffic class 510 associated with the one or more packets 530. The packet engine 508 can be the same as or substantially similar to packet engine 240 described above with respect to FIG. 2. For example, the packet engine 508 can manage kernel-level processing of packets 530 received via network 104. The packet engine 508 can perform encryption/decryption, traffic management such as request-level content switching and request-level cache redirection, and compression and decompression of data.

Traffic class 510 can include a category of network traffic. In embodiments, a traffic class 510 can include a collection of buffers queues, and/or bandwidths allocated to one or more packets 530 in a respective traffic class 510 to provide a determined level of service. The packets 530 can be classified into a traffic class 510 based in part on one or more policies (e.g., network policies, device policies, user policies) and/or based in part on a type of service 275 or application 552 the packet 530 is intended for and/or associated with. Each packet 530 can be classified into at least one traffic class 510. For example, the device 502 can classify or select a traffic class for a packets 530 based in part on application 552 the packet 530 is intended for and/or associated with and/or based in part on a policy or priority level 516 determined by a user or the device 502. The number of traffic classes 510 can vary and be determined based in part on the number of services 275, applications 552 or microservices 475.

The device 502 can include a processing level 512. The processing level 512 can include or correspond to a central processing unit (CPU) load level or CPU load at a particular point in time (e.g., currently, previously, over a defined time period) for one or more processors 504 of the device 502. The processing level 512 can include a processing level 512 or metric corresponding to a level of traffic at or being handled by device 502 and/or one or more processors 504 of the device 502. In embodiments, the processing level 512 can include or correspond to a number of packets 530 received at and/or being handled by device 502.

The device 502 can generate one or more thresholds 514 (e.g., define thresholds, determined thresholds). The thresholds 514 can include or correspond to a magnitude, level, barrier or value established by the device 502 to indicate a defined condition for the device 502. The thresholds 514 can include a processing threshold 514. In embodiments, the processing threshold 514 can include or correspond to a critical processing level 512 (e.g., critical CPU level) of one or more processors 504 of the device 502. For example, when the processing level 512 is greater than the processing threshold 514 can indicate the load at the device 502 is critically high or overloaded, impacting user experience. The device 502 can identify the processing level 512 or load on the device 502 (or packet engine 508) or one or more processors 504 and determine whether the processing level 512 is less than, equal to or greater than the processing threshold 514 established for the device 502. In some embodiments, the device 502 can determine to drop or process a packet 530 based in part on whether or not the processing level 512 is less than, equal to or greater than the processing threshold 514 established for the device 502.

The device 502 can generate or determine one or more priority levels 516 for one or more traffic classes 510. A priority level 516 can include a value or metric assigned to a traffic class 510 to indicate an importance of the respective traffic class 510. In embodiments, the device 502 can generate or determine a priority level 516 for a traffic class 510 and/or a user (or administrator) can determine or select a priority level 516 for a traffic class 510. For example, a first container 550 (or application 552, service 275, microservice 475) can be indicated as high priority and one or more traffic classes 510 corresponding to the first service 275 can be assigned a first priority level 516 and a second container 550 (or application 552, service 275, microservice 475) can be indicated as low priority and one or more traffic classes 510 corresponding to the first service 275 can be assigned a second priority level 516. The second priority level 516 can be less than or a lower priority level than the first priority level 516. The number of priority levels 516 can vary and be determined based in part on the number of services 275 (or applications, microservices) and/or number of traffic classes 510.

The device 502 can include or execute a prioritization algorithm 518. The prioritization algorithm 518 can use or execute a weighting function based in part on a plurality of variables, metrics or properties of an application 552 to determine and select one or more packets 530 to drop. In embodiments, the prioritization algorithm 518 can include or execute a hierarchical weighted fair queueing to determine and select one or more packets 530 to drop in response to the CPU usage level 564 reaching an enter threshold 572. The packets 530 can be weighted and/or selected based in part on a packet priority, a data transmission pattern of a connection 540 (e.g., bulk vs. interactive) and/or a packet queueing time. In embodiments, packets 530 can be weighted and/or selected based in part on one or more configured priorities of one or more containers 550, one or more containerized applications 552, a dynamic priority reduction for high CPU using applications 552, and/or to reduce (e.g., dynamically, automatically) the priority of attack traffic or malicious traffic.

The device 502 can include a database 520. The database 520 can include a structured set of data (e.g., metadata stored for the device 502). For example, the database 520 can include one or more packets 530 and/or metadata corresponding to one or more packets 530. The packets 530 can include, but not limited to, traffic (e.g., requests) received for one or more containers 550 and/or applications 552. The metadata can correspond to or include data or information associated with one or more containers 550, applications 552, microservices 475, one or more packets 530, one or more requests, one or more call chains and/or one or more service graphs 405. In some embodiments, the metadata can include statistics associated with one or more calls between a plurality of containers 550, applications 552, call counts, call times, response times, success rates and/or failure rates.

The device 502 can collect and maintain parameters corresponding to transaction performed by the containers 550 and/or applications 552 when processing one or more packets 530. The parameters can include, but not limited to, a response time of the respective container 550 or application 552 performing one or more transactions. The parameters can include, but not limited to, a failure between the two or more applications 552, a number of times each application 552 has been called, and a rate of success of using the plurality of containers 550 and/or applications 552.

Network 104 may be a public network, such as a wide area network (WAN) or the Internet. In some embodiments, network 104 may be a private network such as a local area network (LAN) or a company Intranet. Network 104 may be the same as or substantially similar to network 104 described above with respect to FIGS. 1A-1B and 4A-4B.

Each of the above-mentioned elements or entities is implemented in hardware, or a combination of hardware and software, in one or more embodiments. Each component of the device 502 may be implemented using hardware or a combination of hardware or software detailed above in connection with FIGS. 1-4C. For instance, each of these elements or entities can include any application, program, library, script, task, service, process or any type and form of executable instructions executing on hardware of a client device (e.g., device 502). The hardware includes circuitry such as one or more processors in one or more embodiments.

Referring now to FIG. 5B, a graph 560 comparing a ratio 562 of dropped packets 568 to transmitted (e.g., sent) packets compared as a function of a CPU usage level 564 (e.g., processing level 512). In the graph 560, the ratio 562 of dropped packets 568 to transmitted packets 566 is represented or shown on the vertical axis and the CPU usage level 564 is represented or shown on the horizontal axis. The value of transmitted packets 566 is represented by the solid line and the value of the dropped packets 568 is represented by the dashed line.

In embodiments, the dropped packet value 568 (e.g., dropped packet count) can be a function of the CPU usage level 564 on the device 502 (e.g., function of the processing level 512 of the one or more processors 504 of the device 502). The device 502 can include multiple thresholds 514 to identify when to begin dropping packets 530 or stop dropping packets 530. For example, the device 502 can include an exit threshold 570 to indicate to stop dropping packets or exit (e.g., end, de-activate) the drop function on the device 502. The device 502 can include an enter threshold 572 to indicate to begin dropping packets or enter (e.g., start, activate) the drop function on the device 502. The device 502 can include a maximum threshold 574 to indicate that the number of dropped packets 568 is equal to the number of transmitted packets 566 and the ratio 562 of dropped to transmitted packets is 1:1. The exit threshold 570, the enter threshold 572 and the maximum threshold 574 can be a function of or correspond to a CPU usage level 564. For example, the exit threshold 570 can be equal to or correspond to a first percentage of the CPU usage level 564. The enter threshold 572 can be equal to or correspond to a second percentage of the CPU usage level 564. The maximum threshold 574 can be equal to or correspond to a third percentage of the CPU usage level 564. In embodiments, the exit threshold 570 can be less than the enter threshold 572. In embodiments, the exit threshold 570 and the enter threshold 572 can be less than the maximum threshold 574.

As shown in FIG. 5B, the ratio 562 of dropped to transmitted packets increases as the CPU usage level or value 564 increases. For example, when the CPU usage level or value 564 reaches or is equal to the enter threshold 572, the device 502 can begin dropping packets 530 or activate a drop mechanism on the device 502 to drop one or more packets 530. The device 502 can determine how many packets 530 to drop based in part on the CPU usage level 564 and/or a priority of the respective packets 530. For example, the device 502 can execute a prioritization algorithm 518 to select one or more packets 530 to drop in response to the CPU usage level 564 reaching the enter threshold 572. In embodiments, the prioritization algorithm 518 can use or execute a hierarchical weighted fair queueing to determine and select one or more packets 530 to drop in response to the CPU usage level 564 reaching the enter threshold 572. The device 502 can select, using the prioritization algorithm 518, the one or more packets 530 to drop based in part on a packet priority, a data transmission pattern of a connection 540 (e.g., bulk vs. interactive) and/or a packet queueing time. In embodiments, the device 502 can select, using the prioritization algorithm 518, the one or more packets 530 to drop based in part on configured priorities of containerized applications 552, a dynamic priority reduction for high CPU using applications 552, and/or reducing (e.g., dynamically, automatically) the priority of attack traffic.

The number of packets 530 selected to drop can include a single packet 530. The number of packets 530 selected to drop can include two or more packets 530 of a plurality of packets 530 received at the device 502. In embodiments, when the CPU usage level 564 reaches, is equal to or falls below the exit threshold 572, the device 502 can stop dropping packets 530 or de-activate a drop mechanism on the device 502 to stop dropping received packets 530. The exit threshold 570, enter threshold 572 and maximum threshold 574 can vary, for example, based in part on the properties of the device 502, configuration of the device 502 and/or a number of packets 530 received at the device 502.

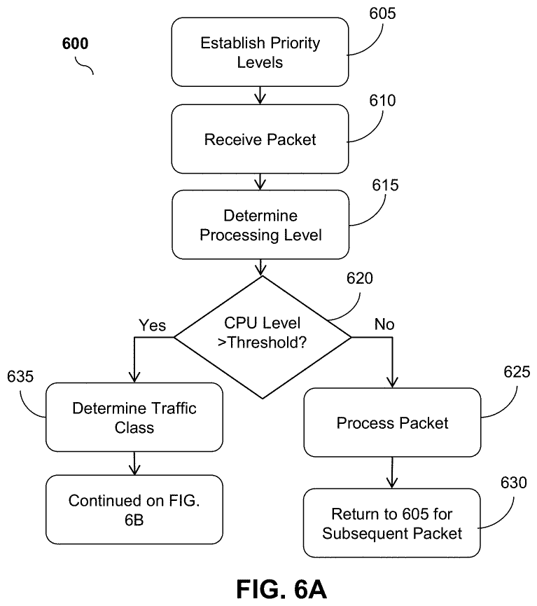

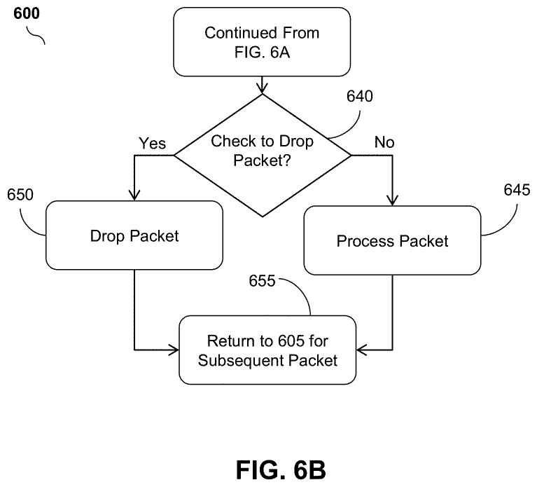

Referring now to FIGS. 6A-6B, depicted is a flow diagram of one embodiment of a method 600 for CPU and priority based random early drop packet processing. The functionalities of the method 600 may be implemented using, or performed by, the components detailed herein in connection with FIGS. 1-5B. In brief overview, the method 600 can include one or more of: establishing priority levels (605), receiving a packet (610), determining a processing level (615), determining if the processing level is greater than a threshold (620), if no, processing the packet (625), receiving a subsequent packet (630), if yes, determining a traffic class (635), determining to drop the packet (640), if no, process the packet (645), if yes, drop the packet (650), and receive or wait for a subsequent packet (655). Any of the foregoing operations may be performed by any one or more of the components or devices described herein, for example, the device 502, processor 504 or packet engine 508.

Referring to (605), and in some embodiments, one or more priority levels can be established. The device 502 can establish a priority level 516 for each traffic class 510 of a plurality of traffic classes 510. The traffic classes 510 can correspond to traffic intended for a microservice 475, a service 275, an application 552 or a container 550 having a plurality of applications 552. The device 502 can determine or establish a priority level 516 for a traffic class 510 based in part on the microservice 475, service 275, application 552 or container 550 the traffic class 510 is associated with and/or a type of microservice 475, service 275, application 552 or container 550 the traffic class 510 is associated with. In some embodiments, a user or administrator can provide a priority level 516 for one or more the microservices 475, services 275, applications 552 or containers 550.

In embodiments, the device 502 can assign a first priority level 516 to a first traffic class 510 associated with a first packet 530 of the plurality of packets 530 and assign a second priority level 516 to a second traffic class 510 associated with a second packet 530 of the plurality of packets 530. The device 502 can assign a first priority level 516 to a first traffic class 510 corresponding to a group of applications 552 packaged in a container 550 and assign a second priority level 516 to a second traffic class 510 with the second traffic class 510 different from the first traffic class 510. For example, the microservices 475, services 275, applications can be prioritized based in part on the function (or service) the respective microservices 475, services 275 or applications provide. In embodiments, the device 502 can establish or select a first priority level 516 (e.g., high priority level) for containerized applications 552 grouped or organized in a common container 550. The device 502 can establish or select the first priority level 516 (e.g., high priority level) to protect traffic or packets 530 corresponding to the containerized applications 552 grouped or organized in a common container 550 such that the respective packets 530 are processed during periods of high CPU usage and other packets 530 not corresponding to containerized applications 552 are dropped.

In one embodiment, a financial service or financial application 552 can be given a first priority level 516, an email application can be given a second priority level 516 and a logging or tracking application can be given a third priority level 516. The financial application 552 can be included in a first container 550 having multiple financial applications 552. The microservices 475 and/or services 275 corresponding to the respective application 552 can be assigned the same priority level 516. The first, second and third priority levels 516 can be different from each other (e.g., higher, lower). The device 502 can assign the traffic classes 510 the same priority level 516 as assigned to the microservices 475, services 275, applications 552 or containers 550 the respective traffic class 510 corresponds to or is associated with. The device 502 can prioritize high priority microservices 475, services 275, applications 552 and containers 550 and traffic corresponding to the high priority microservices 475, services 275, applications 552 and containers 550. The device 502 can de-prioritize or reduce a priority of low priority microservices 475, services 275, applications 552 and containers 550 and traffic corresponding to the low priority microservices 475, services 275, applications 552 and containers 550. The number of priority levels 516 can vary based in part on the number of traffic classes 510 and/or a number of packets 530 received. For example, the device 502 can assign or generate a single priority level 516 or two or more priority levels 516.

Referring to (610), and in some embodiments, a packet can be received. In embodiments, the device 502 can receive a plurality of packets 530. The packets 530 can include or correspond to requests received from one or more clients (e.g., client 102). The device 502 can receive one or more packets 530 and determine to drop or process the packets 530 prior to processing the packets 530. The packets 530 can include or correspond to requests for a microservice 475, service 275, applications 552 and/or containers 550. In embodiments, the device 502 can receive a packet 530, determine the corresponding microservice 475, service 275, application 552 or container 550 and forward or provide the packet 530 to the determined microservice 475, service 275, application 552 or container 550. The packet 530 can include or correspond to a call from a first microservice 475 to a second, different microservice 475. The packet 530 can include a request for at least one service 275, execution of at least one service 275, at least one application 552 and/or execution of at least one application 552. The packet 530 can identify at least one service 275, at least one microservice 475 associated with at least one service 275, at least one application 552 and/or at least one microservice 475 associated with the application 552. For example, a service 275 can include a collection or plurality of microservices 475. In embodiments, a service can include, be built and/or generated using one or more microservices 475 such that each of the one or more microservices 475 perform part of the function of the respective service. In some embodiments, an application 552 can include a collection or plurality of microservices 475. In embodiments, an application 552 can include, be built and/or generated using one or more microservices 475 such that each of the one or more microservices 475 perform part of the function of the respective application 552.

Referring to (615), and in some embodiments, a processing level 512 can be determined. In embodiments, the device 502 can determine a processing level 512 (e.g., CPU load level, CPU usage level 564) of one or more processors 504 of the device 502 prior to processing the packet 530 or plurality of packets 530. The processing level 512 can include a current processing level 512 or a processing level 512 over a determined time period (e.g., previous hour, previous 10 minutes). The device 502 can monitor the network traffic received and collect and maintain statistics including the current processing level 512 or load at the device 502. For example, the device 502 can generate CPU usage reports and statistics indicating the processing level 512 of the device 502 over various time periods. The processing level 512 can be based in part on a number of packets 530 receiving, a number of requests received, and/or a number of calls, for example, between microservices 475.

Referring to (620), and in some embodiments, the processing level can be compared to a processing threshold. The device 502 can compare the processing level 512 to a processing threshold 514. The processing threshold 514 can indicate whether the load or amount of network traffic received at or being handled by the device 502 is greater than a critical level, for example, negatively impacting a user experience or a quality of service. In embodiments, when the processing level 512 is greater than the processing threshold 514, a user experience accessing or interacting with a service 275 or application 552 can be negatively impacted resulting in slow or delayed response times. The device 502 can generate the processing threshold 514 based in part on a number of microservices 475, services 275, applications 552 or containers 550. The device 502 can determine the processing threshold 514 based in part on a desired response time for one or more clients 102 requesting access to or accessing one or more microservices 475, services 275, applications 552 and/or containers 550. The device 502 can determine the processing threshold 514 based in part on a desired quality of service for one or more clients 102 requesting access to or accessing one or more microservices 475, services 275, applications 552 and/or containers 550. The device 502 can compare the processing level 512 to the processing threshold 514 to determine if the processing level 512 is greater than, equal to, or less than the processing threshold 514.

In embodiments, the processing threshold 514 can include or correspond to an exit threshold 570, enter threshold 572 or maximum threshold 574. The device 502 can compare the processing level 512 (e.g., CPU usage level 564) to an enter threshold 572 to determine to initiate dropping of one or more packet 530 and/or execute a prioritization algorithm 518. If the processing level 512 is greater than or equal to the enter threshold 572, the device 502 can initiate dropping of one or more packet 530 and/or execute a prioritization algorithm 518 to select one or more packets 530 to drop. The device 502 can compare the processing level 512 (e.g., CPU usage level 564) to an exit threshold 570 to determine to stop dropping of one or more packet 530 and/or de-activate the prioritization algorithm 518. If the processing level 512 is less than or equal to the exit threshold 572, the device 502 can stop dropping of one or more packet 530 and/or de-activate the prioritization algorithm 518 to select one or more packets 530 to drop. The device 502 can compare the processing level 512 (e.g., CPU usage level 564) to a maximum threshold 574 to determine if the ratio 562 of dropped to transmitted packets is 1:1. If the processing level 512 is equal to the maximum threshold 574, the device 502 can maintain the current number of packets 530 to drop or current percentage of packets 530 to drop, for example, until the processing level 512 is less than the maximum threshold 574.

Referring to (625), and in some embodiments, if the processing level 512 is less than the processing threshold 514, the device 502 can determine to process the packet 530. If the processing level 512 is less than the enter threshold 572, the device 502 can determine to process the packets 530 received at the device 502. In embodiments, the device 502 can determine that the processing level 512 of the one or more processors 504 of the device 502 is less than a processing threshold 514 of the device 502 and process the one or more packets 530 at the device 502. For example, the device 502 can determine that the processing level 512 or load at the device 502 is below or less than a critical level and not negatively impacting a user experience. The device 502 can determine a number of packets 530 received and/or queue to be processed at the device 502 and compare the number of packets 530 to the processing level 512. The device 502 can determine that the processing level 512 does not need to be reduced and that the device 502 can process the packets 530 and maintain the processing level 512 under or less than the processing threshold 514 of the device 502. In embodiments, the device 502 can provide or forward the one or more packets to one or more microservices 475 in response to selecting to process the one or more packets 530. Referring to (630), and in some embodiments, the method 600 can return to (605) to receive a subsequent packet 530 or wait for a subsequent packet 530.

Referring to (635), and in some embodiments, a traffic class can be determined or identified. In embodiments, if the processing level 512 equal to or greater than the processing threshold 514, the device 502 can determine one or more properties of a packet 530. The device 502 can determine or identify a traffic class 510 for a packet 530. The device 502 can determine the one or more traffic classes 510 of the plurality of packets 530. In embodiments, the device 502 can classify a packet 530 into at least one traffic class 510 when the packet 530 is received at the device 502. In embodiments, the device 502 can determine a microservice 475, service 275, application 552 or container 550 the packet 530 is associated with and determine the traffic class 510 for the corresponding microservice 475, service 275, application 552 or container 550. The device 502 can classify the packet 530 into the corresponding traffic class 510. The device 502 can identify metadata for a packet 530 (e.g., from a header portion of the packet 530) and determine or classify the packet 530 into a traffic class 510 using the metadata for the packet 530. The device 502 can select a traffic class 510 for a packet 530 based in part on the type of data included within the packet 530 and/or the type of traffic the packet 530 is associated with.

Referring to (640), and in some embodiments, a determination can be made to drop or process a packet. The device 502 can select one or more packets 530 of the plurality of packets 530 to process or drop responsive to the priority level 516 of one or more traffic classes 510 associated with the one or more packets 530 and the processing level 512 of the one or more processors 504 of the device 502. The device 502 can make a determination to drop a packet 530 based in part on the priority level of the traffic class 510 of the packet 530. For example, the device 502 can group or categorize traffic classes 510 based in part on the priority level 516 of the traffic classes 510. In embodiments, the device 502 can rank or order the traffic classes 510 based in part on the priority level 516 of the traffic classes 510. The device 502 can use the processing level 512 (e.g., current processing level 512) to determine if and how much the processing level 512 needs to be reduced or monitored to maintain a quality of service or user experience level.

In embodiments, the device 502 can determine the number of packets 530 received at a defined point in time or currently queueing and waiting to be processed. The device 502 can compare the number of packets 530 to the processing level 512 to determine the number of packets 530 that should be dropped to maintain the processing level 512 under the processing threshold 514 and the number of packets 530 that can be processed and maintain the processing level 512 under the processing threshold 514. The device 502, responsive to the comparison, can determine the priority level 516 that can serve as a priority level threshold. For example, the device 502 can select a priority level 516 to server as a priority level threshold such that one or more priority levels 516 less than or below the selected priority level 516 can be marked as low priority and one or more packets 530 associated with one or more low priority levels 516 can be dropped. The device 502 can select a priority level 516 to server as a priority level threshold such that one or more priority levels 516 equal to or greater than (e.g., above) the selected priority level 516 can be marked as high priority and one or more packets 530 associated with one or more high priority levels 516 can be processed. The selected priority level 516 can be selected based in part on the number of received packets 530 or queued packets 530 corresponding to the one or more priority levels 516 at or above (e.g., greater than) the selected priority level 516.

The device 502 can identify one or more traffic classes 510 corresponding to, having or associated with the selected priority level 516 or one or more higher priority levels 516 and mark the identified traffic classes 510 for processing. The device 502 can identify one or more traffic classes 510 corresponding to, having or associated with one or more priority levels 516 that are less than the selected priority level 516 and mark the identified traffic classes 510 to be dropped. The device 502 can determine if the traffic class 510 corresponding to or associated with the packet 530 is marked or indicated to be processed or dropped. The device 502 can execute a prioritization algorithm 518 to select one or more packets 530 to drop. In embodiments, when the processing level 512 reaches or is equal to an enter threshold 572, the device 502 can begin dropping packets 530 or activate a drop mechanism (e.g., prioritization algorithm 518) on the device 502 to drop one or more packets 530. The device 502 can determine how many packets 530 to drop based in part on the CPU usage level 564 and/or a priority of the respective packets 530.

The device 502 can determine a total number of packets 530 to drop or a percentage of packets 530 or a plurality of packets 530 to drop based in part on the processing level 512 (e.g., CPU usage level 564) of the one or more processors 504 of the device 502. The number of packets 530 selected to drop or a percentage of packets 530 or a plurality of packets 530 selected to drop can increase as the processing level 512 increases, for example, until the processing level 512 is equal to the maximum threshold 574. The number of packets 530 selected to drop or a percentage of packets 530 or a plurality of packets 530 selected to drop can decrease as the processing level 512 decreased, for example, until the processing level 512 is equal to or less than the exit threshold 570. The device 502, after determining the number or percentage of packets 530 to drop, can execute the prioritization algorithm 518 to select one or more packets 530 to drop in response to the processing level 512 reaching the enter threshold 572. In embodiments, the prioritization algorithm 518 can assign or apply weighs or weighted values to one or more packets 530 based in part on a traffic class 510 associated with the packet 530, a priority level 516 associated with the packet 530, a packet priority, a data transmission pattern of a connection 540 (e.g., bulk vs. interactive) and/or a packet queueing time. In embodiments, the prioritization algorithm 518 can assign or apply weighs or weighted values to one or more packets 530 based in part on priorities of one or more containers 550, priorities of one or more containerized applications 552, a dynamic priority reduction for high CPU using applications 552, and/or to reduce (e.g., dynamically, automatically) the priority of attack traffic or malicious traffic. In some embodiments, the prioritization algorithm 518 can include or execute a hierarchical weighted fair queueing to determine and select one or more packets 530 to drop in response to the CPU usage level 564 reaching the enter threshold 572. The number of packets 530 selected to drop can include a single packet 530. The number of packets 530 selected to drop can include two or more packets 530 of a plurality of packets 530 received at the device 502. In embodiments, when the CPU usage level 564 reaches, is equal to or falls below the exit threshold 572, the device 502 can stop dropping packets 530 or de-activate a drop mechanism on the device 502 to stop dropping received packets 530. The exit threshold 570, enter threshold 572 and maximum threshold 574 can vary, for example, based in part on the properties of the device 502, configuration of the device 502 and/or a number of packets 530 received at the device 502.

Referring to (645), and in some embodiments, the device 502 can determined to process the packet. The device 502 can make the determination to process a packet 530 based in part on the processing level 512 being at, near or over a processing threshold 514 of the device 502 and/or a priority level 516 of a traffic class 510 corresponding to the respective packet 530. The device 502 can make the determination to process a packet 530 based in part on an output of the prioritization algorithm 518 and/or a weight value assigned to a packet 530 using the prioritization algorithm 518. The device 502 can select one or more packets 530 to process when the processing level 512 is near or within a defined range of the processing threshold 514 of the device 502 and maintain the processing level 512 such that the processing level 512 is less than the processing threshold 514 of the device 502. The device 502 can select one or more packets 530 associated with higher priority levels 516 to protect high priority traffic. The device 502 can select one or more packets 530 assigned higher or greater weighted values using the prioritization algorithm 518. For example, the device 502 can establish a first priority level 516 (e.g., high priority level) for containerized applications 552 grouped or organized in a common container 550. The first priority level 516 can be greater than the priority threshold to protect traffic or packets 530 corresponding to the containerized applications 552 grouped or organized in a common container 550 such that the respective packets 530 are processed during periods of high CPU usage. In embodiments, the device 502 can determine to process a first packet 530 based on the first priority level 516 of the first traffic class 510. The device 502 can determine that the traffic class 510 corresponding to the packet 530 is marked or indicated as high priority and the device 502 can determine or select to process the packet 530. The packet 530 can correspond to a high priority microservice 475, service 275 or application. The device 502 can prioritize important or critical network traffic (e.g., packets 530) during high load or high processing level 512 periods to protect the high priority network traffic and maintain a desired quality of service or user experience.

Referring to (650), and in some embodiments, the device 502 can determine to drop the packet. The device 502 can make the determination to drop a packet 530 based in part on the processing level 512 being at, near or over a processing threshold 514 of the device 502 and/or a priority level 516 of a traffic class 510 corresponding to the respective packet 530. The device 502 can make the determination to drop a packet 530 based in part on an output of the prioritization algorithm 518 and/or a weight value assigned to a packet 530 using the prioritization algorithm 518. The device 502 can select one or more packets 530 to be dropped to avoid the processing level 512 reaching or exceeding the processing threshold 514 of the device 502 or to reduce the processing level 512 such that the processing level 512 is less than the processing threshold 514 of the device 502. The device 502 can select one or more packets 530 associated with lower priority levels 516 to be dropped to protect high priority traffic. The device 502 can select one or more packets 530 to drop having lower weighted values using the prioritization algorithm 518. The lower priority packets 530 can be dropped to maintain the processing level 512 of the one or more processors 504 of the device 502 under or within a defined range of the processing threshold 514 and allow for the high priority packets 530 to be processed. In embodiments, the device 502 can determine that the processing level 512 is greater than a processing threshold 514 of the device and select the one or more packets 530 to be dropped based on the priority level 516 of the one or more traffic classes 510 associated with the one or more packets 530. In embodiments, the device 502 can select the one or more packets 530 to be dropped prior to processing at the device 502 responsive to the processing level 512 being greater than a processing threshold 514 of the device 502. The device 502 can determine that the traffic class 510 corresponding to the packet 530 is marked or indicated as low priority and the device 502 can determine or select to drop the packet 530. The device 502 can drop the packet 530 prior to processing the packet 530. The device 502 can determine to drop a second packet 530 prior to processing the second packet 530 based on the second priority level 516 of the second traffic class 510. In embodiments, the device 502 can drop the packet 530 corresponding to low priority traffic to maintain the processing level 512 at or below the processing threshold 514. The device 502 can prioritize important or critical network traffic (e.g., packets 530) during high load or high processing level 512 periods to reduce or eliminate low priority network traffic that may negatively impact a desired quality of service or user experience. In embodiments, the number or percentage of packets 530 to drop can increase as the processing level 512 (e.g., CPU usage level 564) of the device 502 increases, for example, until the CPU usage level 564 is equal to a maximum threshold 574 and/or a ratio 562 of dropped packets to transmitted packets is 1:1 (e.g., number or percentage of dropped packets 568 is equal to the number or percentage of transmitted packets 566).

In embodiments, the device 502 can dynamically or automatically modify a priority level 516 of a traffic class 510 based in part on the processing level 512 of the one or more processors 505 of device 502 and/or the type of traffic. For example, the device 502 can monitor the processing level 512 and collect and generate statistics, such as but not limited, CPU usage reports. The device 502 can detect when the processing level 512 is approaching, near or within a defined range of the processing threshold 514. In response to the increasing processing level 516, the device 502 can modify a priority level 516 for one or more traffic classes 510 to maintain the processing level 512 at a current level and/or maintain the processing level 512 such that the processing level 512 is less than the processing threshold 514 of the device 502. The device 502 can generate an alert threshold that indicates when a priority level 516 for one or more traffic classes 510 should be modified to maintain the processing level 512 such that the processing level 512 is less than the processing threshold 514 of the device 502. For example, when the processing level 512 reaches or is equal to the alert threshold, the device 502 can receive an indication and begin modifying (e.g., reducing, de-prioritizing) the priority level 516 of one or more traffic classes 510. The alert threshold can be less than the processing threshold 514 and be within a defined range of the processing threshold 514 to maintain a quality of service and user experience for one or more clients accessing one or more microservices 475, services 275, or applications via the device 502. In some embodiments, the device 502 can automatically de-prioritize the priority level 516 of one or more traffic classes 510 in response to the processing level 512 reaching or equaling the alert threshold. The modified priority level 516 can cause the device 502 to drop one or more packets 530 corresponding to the traffic classes 510 to maintain the processing level 512 such that the processing level 512 is less than the processing threshold 514 of the device 502.

In embodiments, the device 502 can determine that a packet 530 includes, corresponds to or is associated malicious traffic or attack traffic. For example, the device 502 can determine that a first traffic class 510 corresponds to malicious traffic. The device 502 can modify or dynamically modify the priority level of the first traffic class 510. In embodiments, the device 502 can reduce or lower the priority level 516 to a lowest level or provide the traffic class 510 a priority level 516 that indicates malicious traffic such that all traffic and packets 530 within the traffic class 510 are dropped. The device 502 can drop, prior to processing, one or more packets 530 associated with the first traffic class 510. The device 502 can automatically de-prioritize malicious traffic to prevent attacks and provide a defense against various forms of attacks (e.g., DOS attacks). In some embodiments, the device 502 can automatically de-prioritize the priority level 516 of one or more traffic classes 510 in response to determining the traffic classes 510 include or correspond to malicious traffic. Referring to (655), and in some embodiments, the method 600 can return to (605) to receive a subsequent packet 530 or wait for a subsequent packet 530.

Various elements, which are described herein in the context of one or more embodiments, may be provided separately or in any suitable subcombination. For example, the processes described herein may be implemented in hardware, software, or a combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It will be further understood that various changes in the details, materials, and arrangements of the parts that have been described and illustrated herein may be made by those skilled in the art without departing from the scope of the following claims.

We claim:

1. A method comprising:
establishing, by a device, a priority level for each traffic class of a plurality of traffic classes;
receiving, by the device, a plurality of packets;
determining, by the device, a processing level of one or more processors of the device prior to processing the plurality of packets; and
selecting, by the device, one or more packets of the plurality of packets to drop responsive to the priority level of one or more traffic classes associated with the one or more packets and the processing level of the one or more processors.

2. The method of claim 1, further comprising:
assigning, by the device, a first priority level to a first traffic class corresponding to a group of applications packaged in a container; and
assigning, by the device, a second priority level to a second traffic class, the second traffic class different from the first traffic class.

3. The method of claim 2, further comprising:
determining, by the device, to process a first packet associated with the first traffic based on the first priority level of the first traffic class.

4. The method of claim 2, further comprising:
determining, by the device, to drop a second packet associated with the second traffic class prior to processing the second packet based on the second priority level of the second traffic class.

5. The method of claim 1, further comprising:
selecting, by the device, the one or more packets to be dropped prior to processing at the device responsive to the processing level of the one or more processors being greater than a processing threshold of the device.

6. The method of claim 1, further comprising:
determining, by the device, that the processing level of the one or more processors is greater than a processing threshold of the device; and
selecting, by the device, the one or more packets to be dropped based on the priority level of the one or more traffic classes associated with the one or more packets.

7. The method of claim 1, further comprising:
determining, by the device, the processing level of the one or more processors is equal to or greater than a processing threshold of the device; and
selecting, by the device using a prioritization algorithm, the one or more packets of the plurality of packets to drop.

8. The method of claim 1, further comprising:
determining, by the device, the processing level of the one or more processors is less than a processing threshold of the device;
stopping, by the device, dropping of the one or more packets of the plurality of packets; and
processing, by the device, the one or more packets at the device.

9. The method of claim 1, further comprising:
determining, by the device, a first traffic class corresponds to malicious traffic;
dynamically modifying, by the device, the priority level of the first traffic class; and
dropping, by the device prior to processing, at least one packet of the plurality of packets associated with the first traffic class.

10. A system comprising:
a device comprising one or more processors, coupled to memory, wherein the device is configured to:
establish a priority level for each traffic class of a plurality of traffic classes;
receive a plurality of packets;
determine a processing level of the one or more processors of the device prior to processing the plurality of packets; and
select one or more packets of the plurality of packets to drop responsive to the priority level of one or more traffic classes associated with the one or more packets and the processing level of the one or more processors.

11. The system of claim 10, wherein the device is further configured to:
assign a first priority level to a first traffic class corresponding to a group of applications packaged in a container; and
assign a second priority level to a second traffic class, the second traffic class different from the first traffic class.

12. The system of claim 11, wherein the device is further configured to:
determine to process a first packet associated with the first traffic based on the first priority level of the first traffic class.

13. The system of claim 11, wherein the device is further configured to:
determine to drop a second packet associated with the second traffic class prior to processing the second packet based on the second priority level of the second traffic class.

14. The system of claim 10, wherein the device is further configured to:
select the one or more packets to be dropped prior to processing at the device responsive to the processing level of the one or more processors being greater than a processing threshold of the device.

15. The system of claim 10, wherein the device is further configured to:
determine that the processing level of the one or more processors is greater than a processing threshold of the device; and
select the one or more packets to be dropped based on the priority level of the one or more traffic classes associated with the one or more packets.

16. The system of claim 10, wherein the device is further configured to:
determine the processing level of the one or more processors is equal to or greater than a processing threshold of the device; and
select, using a prioritization algorithm, the one or more packets of the plurality of packets to drop.

17. The system of claim 10, wherein the device is further configured to:
determine that the processing level of the one or more processors is less than a processing threshold of the device;
stop dropping of the one or more packets of the plurality of packets; and
process the one or more packets at the device.

18. The system of claim 10, wherein the device is further configured to:
determine a first traffic class corresponds to malicious traffic;
dynamically modify the priority level of the first traffic class; and
drop, prior to processing, at least one packet of the plurality of packets associated with the first traffic class.

19. A non-transitory computer readable medium storing program instructions for causing one or more processors to:
establish a priority level for each traffic class of a plurality of traffic classes;
receive a plurality of packets;
determine a processing level of the one or more processors of a device prior to processing the plurality of packets; and
select one or more packets of the plurality of packets to drop responsive to the priority level of one or more traffic classes associated with the one or more packets and the processing level of the one or more processors.

20. The non-transitory computer readable medium of claim 19, wherein the program instructions further cause the one or more processors to:
assign a first priority level to a first traffic class corresponding to a group of applications packaged in a container;
assign a second priority level to a second traffic class, the second traffic class different from the first traffic class; and
determine to process a first packet associated with the first traffic based on the first priority level of the first traffic class.
